(19) United States
(12) Patent Application Publication
(10) Pub. No.: US 2018/0100120 A1
(43) Pub. Date: Apr. 12, 2018

(54) METHOD FOR PREVENTING OR MINIMIZING ELECTROSTATIC DISCHARGE AND DIELECTRIC BREAKDOWN IN ELECTRIC VEHICLE POWERTRAINS

(71) Applicant: ExxonMobil Research and Engineering Company, Annandale, NJ (US)

(72) Inventors: Samuel Flores-Torres, Burlington, NJ (US); David G.L. Holt, Medford, NJ (US); James T. Carey, Medford, NJ (US)

(21) Appl. No.: 15/725,764

(22) Filed: Oct. 5, 2017

Related U.S. Application Data
(60) Provisional application No. 62/405,289, filed on Oct. 7, 2016.

(51) Int. Cl. C10M 169/04; C10M 101/02; C10M 171/02; B60K 6/26; C10G 45/58

(52) U.S. Cl. CPC C10M 169/048; C10M 101/02; C10M 171/02; B60K 6/26; C10N 2230/43; C10M 2203/06; C10M 2203/106; C10N 2240/04; C10G 45/58

(57) ABSTRACT

This disclosure relates to a method for preventing or minimizing electrostatic discharge and dielectric breakdown in an electric vehicle powertrain by controlling electrical conductivity over a lifetime of a lubricating oil in an electric vehicle powertrain lubricated with the lubricating oil. The lubricating oil has a composition including a lubricating oil base stock as a major component, and an additive package as a minor component comprising one or more lubricating oil additives, and an effective amount of one or more conductivity agents, as a minor component. The lubricating oil has an electrical conductivity from 10 pS/m to 20,000 pS/m, a dielectric constant of 1.6 to 3.6, with a ratio of electrical conductivity-to-dielectric constant from 1,000 to 10,000. Also provided are methods for obtaining a desired electrical conductivity-to-dielectric constant ratio of a lubricating oil for an electric powertrain and powertrain components and methods for lubricating an electric vehicle powertrain and powertrain components.

### CROSS-REFERENCE TO RELATED APPLICATIONS

This application claims priority to U.S. Provisional Application Ser. No. 62/405,289 filed Oct. 7, 2016, which is herein incorporated by reference in its entirety. This application is also related to four copending U.S. applications, filed on even date herewith, and identified by the following Attorney Docket numbers and titles: 2016EM271-US2 entitled “Lubricating Oil Compositions for Electric Vehicle Powertrains”; 2016EM272-US2 entitled “Method for Controlling Electrical Conductivity of Lubricating Oils in Electric Vehicle Powertrains”; 2017EM320 entitled “Low Conductivity Lubricating Oils For Electric And Hybrid Vehicles”; and 2017EM319 entitled “High Conductivity Lubricating Oils For Electric And Hybrid Vehicles”. Each of these co-pending US applications is hereby incorporated by reference herein in its entirety.

### FIELD

This disclosure provides methods for preventing or minimizing electrostatic discharge and dielectric breakdown in an electric vehicle powertrain. This disclosure also provides methods for lubricating an electric vehicle powertrain and powertrain components. This disclosure provides methods for controlling electrical conductivity over a lifetime of a lubricating oil in an electric vehicle powertrain lubricated with the lubricating oil. This disclosure also provides methods for obtaining a desired electrical conductivity of a lubricating oil for an electric vehicle powertrain.

### BACKGROUND

A major challenge in electric vehicle powertrain lubricant formulating is controlling lubricant electrical conductivity over the lifetime of the lubricant. In particular, the challenge to electric vehicle powertrain lubricant compositions is achieving oxidation stability, deposit control, corrosion inhibition, and lubricant compatability with electric vehicle powertrain components and materials over a broad temperature range.

For example, copper is present in the electric systems of electric vehicle powertrains and requires protection at high temperatures. Planetary gear sets, typically fabricated from ferrous alloys and steels, are used in electric vehicle powertrains and also require good protection. Suitable lubricant compositions, however, may use sulfur-containing performance additives in achieving good gear protection, but on balance, may limit sulfur concentrations in order to achieve good copper protection.

Additionally, in electric vehicle powertrains, lubricant electrical conductivity needs to be at the right level and maintained over the service lifetime of the lubricating fluid. If lubricant electrical conductivity is too low, then arcing (e.g., electrostatic buildup and discharge) among the electrified system components can occur. If lubricant electrical conductivity is too high, then the electric vehicle powertrains will adversely leak charge.

Also, oil-derived lubricating properties must be maintained despite exposure to high surface temperatures of electric powertrain components. However, this lube stability must be balanced with other lubricant properties such as low viscosity and achieving good gear protection.

Despite advances in lubricant oil technology in electric vehicles, there exists a need for an electric vehicle powertrain lubricant composition having desired lubricant electrical conductivity over the lifetime of the lubricant. In particular, there is a need for electric vehicle powertrain lubricant composition having oxidation stability, deposit control, corrosion inhibition, and lubricant compatibility with electric vehicle powertrain components and materials over a broad temperature range.

### SUMMARY

This disclosure relates in part to a method for preventing or minimizing electrostatic discharge and dielectric breakdown in an electric vehicle powertrain. The method comprises controlling electrical conductivity over a lifetime of a lubricating oil in an electric vehicle powertrain lubricated with the lubricating oil. The lubricating oil has a composition comprising a lubricating oil base stock as a major component, and one or more lubricating oil additives, as a minor component, and one or more conductivity agents, as a minor component. The lubricating oil has an electrical conductivity from about 10 pS/m to about 20,000 pS/m, a dielectric constant of about 1.6 to about 3.6, with a ratio of electrical conductivity-to-dielectric constant from about 1,000 to about 10,000, a kinematic viscosity from about 2 cSt to about 20 cSt at 100° C., a total acid number (TAN) less than about 3, less than about 200 ppm active sulfur, and a viscosity index (VI) greater than about 50.

This disclosure also relates in part to a method for preventing or minimizing electrostatic discharge and dielectric breakdown in an electric vehicle powertrain. The method comprises controlling electrical conductivity over a lifetime of a lubricating oil in an electric vehicle powertrain lubricated with the lubricating oil. The lubricating oil has a composition comprising at least about 70 weight percent of a lubricating oil base stock, and from about 0.01 to about 30 weight percent of an additive package, wherein comprises one or more of from about 0.01 to about 5 weight percent of an antioxidant, from about 0.01 to about 10 weight percent of a detergent, from about 0.01 to about 20 weight percent of a dispersant, from about 0.01 to about 5 weight percent of an antiwear agent, from about 0.01 to about 5 weight percent of a corrosion inhibitor, from about 0 to about 20 weight percent of a viscosity modifier, from about 0.01 to about 5 weight percent of a metal passivator, and from about 0.01 to about 30 weight percent of a conductivity agent. Each weight percent is based on the total weight of the lubricating oil. The lubricating oil has an electrical conductivity from about 10 pS/m to about 20,000 pS/m, a dielectric constant of about 1.6 to about 3.6, with a ratio of electrical conductivity-to-dielectric constant from about 1,000 to about 10,000, a kinematic viscosity from about 2 cSt to about 20 cSt at 100° C., a total acid number (TAN) less than about 3, less than about 200 ppm active sulfur, and a viscosity index (VI) greater than about 50.

This disclosure further relates in part to a method for obtaining a desired electrical conductivity of a lubricating oil for an electric vehicle powertrain. The method comprises: selecting at least one lubricating oil base stock from a Group I, Group II, Group III, Group IV, and Group V base oil; selecting at least one additive package, comprising one or more lubricating oil additives from an antioxidant, a detergent, a dispersant, an antiwear additive, a corrosion inhibitor, a viscosity modifier, and a metal passivator; selecting one or more conductivity agents; selecting amounts of the at least one lubricating oil base stock, the at least one additive package, and the one or more conductivity agents; and blending the selected at least one lubricating oil base stock, the selected at least one additive package, and the selected one or more conductivity agents, in the selected amounts, sufficient to obtain a desired electrical conductivity of the lubricating oil. The lubricating oil has an electrical conductivity from about 10 pS/m to about 20,000 pS/m, a dielectric constant of about 1.6 to about 3.6, with a ratio of electrical conductivity-to-dielectric constant from about 1,000 to about 10,000, a kinematic viscosity from about 2 cSt to about 20 cSt at 100° C., a total acid number (TAN) less than about 3, less than about 200 ppm active sulfur, and a viscosity index (VI) greater than about 50.

This disclosure also relates in part to a method for lubricating an electric vehicle powertrain. The method comprises providing a lubricating oil, and bringing into contact the lubricating oil with the electric vehicle powertrain. The lubricating oil has a composition comprising a lubricating oil base stock as a major component, and one or more lubricating oil additives, as a minor component, and one or more conductivity agents, as a minor component. The lubricating oil has an electrical conductivity from about 10 pS/m to about 20,000 pS/m, a dielectric constant of about 1.6 to about 3.6, with a ratio of electrical conductivity-to-dielectric constant from about 1000 to about 10,000, a kinematic viscosity from about 2 cSt to about 20 cSt at 100° C., a total acid number (TAN) less than about 3, less than about 200 ppm active sulfur, and a viscosity index (VI) greater than about 50.

This disclosure further relates in part to a method for lubricating an electric vehicle powertrain. The method comprises providing a lubricating oil, and bringing into contact the lubricating oil with the electric vehicle powertrain. The lubricating oil has a composition comprising at least about 70 weight percent of a lubricating oil base stock, and from about 0.01 to about 30 weight percent of an additive package, wherein comprises one or more of from about 0.01 to about 5 weight percent of an antioxidant, from about 0.01 to about 10 weight percent of a detergent, from about 0.01 to about 20 weight percent of a dispersant, from about 0.01 to about 5 weight percent of an antiwear agent, from about 0.01 to about 5 weight percent of a corrosion inhibitor, from about 0 to about 20 weight percent of a viscosity modifier, from about 0.01 to about 5 weight percent of a metal passivator, and from about 0.01 to about 30 weight percent of a conductivity agent. Each weight percent is based on the total weight of the lubricating oil. The lubricating oil has an electrical conductivity from about 10 pS/m to about 20,000 pS/m, a dielectric constant of about 1.6 to about 3.6, with a ratio of electrical conductivity-to-dielectric constant from about 1,000 to about 10,000, a kinematic viscosity from about 2 cSt to about 20 cSt at 100° C., a total acid number (TAN) less than about 3, less than about 200 ppm active sulfur, and a viscosity index (VI) greater than about 50.

This disclosure further relates in part to an electric vehicle comprising an electric vehicle powertrain, and a lubricating oil which is in contact with the electric vehicle powertrain. The lubricating oil has a composition comprising a lubricating oil base stock as a major component, and one or more lubricating oil additives, as a minor component, and one or more conductivity agents, as a minor component. The lubricating oil has an electrical conductivity from about 10 pS/m to about 20,000 pS/m, a dielectric constant of about 1.6 to about 3.6, with a ratio of electrical conductivity-to-dielectric constant from about 1,000 to about 10,000, a kinematic viscosity from about 2 cSt to about 20 cSt at 100° C., a total acid number (TAN) less than about 3, less than about 200 ppm active sulfur, and a viscosity index (VI) greater than about 50.

This disclosure further relates in part to an electric vehicle comprising an electric vehicle powertrain, and a lubricating oil which is in contact with the electric vehicle powertrain and powertrain components. The lubricating oil has a composition comprising at least about 70 weight percent of a lubricating oil base stock, and from about 0.01 to about 30 weight percent of an additive package, wherein comprises one or more of from about 0.01 to about 5 weight percent of an antioxidant, from about 0.01 to about 10 weight percent of a detergent, from about 0.01 to about 20 weight percent of a dispersant, from about 0.01 to about 5 weight percent of an antiwear agent, from about 0.01 to about 5 weight percent of a corrosion inhibitor, from about 0 to about 20 weight percent of a viscosity modifier, from about 0.01 to about 5 weight percent of a metal passivator, and from about 0.01 to about 30 weight percent of a conductivity agent. Each weight percent is based on the total weight of the lubricating oil. The lubricating oil has an electrical conductivity from about 10 pS/m to about 20,000 pS/m, a dielectric constant of about 1.6 to about 3.6, with a ratio of electrical conductivity-to-dielectric constant from about 1,000 to about 10,000, a kinematic viscosity from about 2 cSt to about 20 cSt at 100° C., a total acid number (TAN) less than about 3, less than about 200 ppm active sulfur, and a viscosity index (VI) greater than about 50.

This disclosure yet further relates in part to an electric vehicle powertrain comprising an electric motor, a transmission, and a lubricating oil which is in contact with the electric motor and the transmission. The lubricating oil has a composition comprising a lubricating oil base stock as a major component, and one or more lubricating oil additives, as a minor component, and one or more conductivity agents, as a minor component. The lubricating oil has an electrical conductivity from about 10 pS/m to about 20,000 pS/m, a dielectric constant of about 1.6 to about 3.6, with a ratio of electrical conductivity-to-dielectric constant from about 1,000 to about 10,000, a kinematic viscosity from about 2 cSt to about 20 cSt at 100° C., a total acid number (TAN) less than about 3, less than about 200 ppm active sulfur, and a viscosity index (VI) greater than about 50.

This disclosure further relates in part to an electric vehicle powertrain comprising an electric motor, a transmission, and a lubricating oil which is in contact with the electric motor and the transmission. The lubricating oil has a composition comprising at least about 70 weight percent of a lubricating oil base stock, and from 0.01 to about 30 weight percent of an additive package, wherein comprises one or more of from about 0.01 to about 5 weight percent of an antioxidant, from about 0.01 to about 10 weight percent of a detergent, from about 0.01 to about 20 weight percent of a dispersant, from about 0.01 to about 5 weight percent of an antiwear agent, from about 0.01 to about 5 weight percent of a corrosion inhibitor, from about 0 to about 20 weight percent of a viscosity modifier, from about 0.01 to about 5 weight percent of a metal passivator, and from about 0.01 to about 30 weight percent of a conductivity agent. Each weight percent is based on the total weight of the lubricating oil. The lubricating oil has an electrical conductivity from about 10 pS/m to about 20,000 pS/m, a dielectric constant of about 1.6 to about 3.6, with a ratio of electrical conductivity-to-dielectric constant from about 1,000 to about 10,000, a kinematic viscosity from about 2 cSt to about 20 cSt at 100° C., a total acid number (TAN) less than about 3, less than about 200 ppm active sulfur, and a viscosity index (VI) greater than about 50.

It has been surprisingly found that, in accordance with this disclosure, improvements in preventing or minimizing electrostatic discharge and dielectric breakdown in an electric vehicle powertrain are obtained in an electric vehicle powertrain lubricated with a lubricating oil, by including one or more lubricating oil additives in the lubricating oil (e.g., antioxidant, detergent, dispersant, antiwear agent, corrosion inhibitor, viscosity modifier, and metal passivator). The addition of the one or more lubricating oil additives affords greater improvements in controlling electrical conductivity over the lifetime of a lubricating oil in an electric vehicle powertrain lubricated with the lubricating oil.

This disclosure relates to lubricating oils that include, for example, oils of lubricating viscosity, working fluids, and oil-based coolants. This disclosure also relates to the lubrication of electric vehicles that comprise electric vehicle powertrains that include, for example, electric vehicle powertrain systems, electromechanical systems, kinetic energy recovery systems, or combinations thereof. In this disclosure, electric vehicles include, for example, all-electric vehicles, and hybrid or hybrid electric vehicles, which may have any of a variety of parallel or series electromechanical configurations.

Other objects and advantages of the present disclosure will become apparent from the detailed description that follows.

### DETAILED DESCRIPTION

All numerical values within the detailed description and the claims herein are modified by “about” or “approximately” the indicated value, and take into account experimental error and variations that would be expected by a person having ordinary skill in the art.

It has now been found that electrostatic discharge and dielectric breakdown can be prevented or minimized in an electric vehicle powertrain lubricated with a lubricating oil that has one or more lubricating oil additives (e.g., antioxidant, detergent, dispersant, antiwear additive, corrosion inhibitor, viscosity modifier, and metal passivator), and one or more conductivity agents in the lubricating oil. Conductivity agents increase the conductivity of a lubricating or working fluid by a tangible quantity, for example, an increment of +100 pS/m or more, when added to such fluid in an effective amount. The lubricating oil has a composition comprising a lubricating oil base stock as a major component, the one or more lubricating oil additives, as a minor component, and the one or more conductivity agents, as a minor component. The lubricating oils of this disclosure are particularly advantageous as passenger electric vehicle powertrain oil products. The lubricating oils that contain one or more lubricating oil additives are particularly useful in controlling electrical conductivity in low viscosity electric vehicle powertrain oils. In one aspect, the lubricating oils of this disclosure that contain one or more lubricating oil additives are particularly useful in controlling lubricant electrical conductivity to improve bearing-related electric discharge performance, where the ratio of conductivity-to-dielectric constant is equal to or greater than about 1,000, and may particularly range from about 1,000 to about 10,000. In another aspect, the lubricating oils of this disclosure that contain one or more lubricating oil additives are particularly useful in controlling lubricant electrical conductivity to minimize battery drainage and improve battery lifetime, where the ratio of conductivity-to-dielectric constant is less than about 1,000.

In an embodiment, improved lubricant electrical conductivity control can be attained in an electric vehicle powertrain lubricated with a lubricating oil that has one or more lubricating oil additives (e.g., antioxidant, detergent, dispersant, antiwear additive, corrosion inhibitor, viscosity modifier, and metal passivator) in the lubricating oil. The lubricating oil has a composition comprising a lubricating oil base stock as a major component, and the one or more lubricating oil additives, as a minor component. The lubricating oils of this disclosure are particularly advantageous as passenger electric vehicle powertrain oil products. The lubricating oils that contain one or more lubricating oil additives are particularly useful in controlling electrical conductivity in low-viscosity electric vehicle powertrain oils.

In another embodiment, lubricant electrical conductivity control in electric vehicle powertrains is improved and at least one of oxidation stability, deposit control, corrosion inhibition, and lubricant compatability with electric vehicle powertrain components and materials over a broad temperature range, are maintained or improved as compared to lubricant electrical conductivity control, oxidation stability, deposit control, corrosion inhibition, and lubricant compatability with electric vehicle powertrain components and materials over a broad temperature range, achieved using a lubricating oil containing a minor component other than the one or more lubricating oil additives.

The lubricant compositions of this disclosure provide advantaged lubricant electrical conductivity control, including advantaged oxidation stability, deposit control and corrosion inhibition, performance in the lubrication of electric vehicle powertrains which comprise, for example, one or more of drivelines, transmissions, differentials, gears, gear trains, gear sets, gear boxes, bearings, bushings, axles [front axle(s) and/or rear axle(s)], turbines, compressors, pumps, hydraulic systems, batteries, capacitors, electric motors, drive motors, generators, AC/DC converters, alternators, transformers, kinetic energy converters, kinetic energy recovery systems, and the like. In an embodiment, a single lubricant composition is used in the electric vehicle powertrain. In another embodiment, more than one lubricant composition is used in the electric vehicle powertrain, for example, one lubricant composition for the transmission and another lubricant composition for another component of the powertrain. An electric vehicle powertrain system includes the combination of an electric vehicle powertrain (and components) and a lubricating oil or working fluid that are used in such service.

Yet further, the lubricant compositions of this disclosure provide advantaged lubricant electrical conductivity control, including advantaged oxidation stability, deposit control and corrosion inhibition, performance under diverse lubrication regimes of electric vehicle powertrains, that include, for example, hydrodynamic, elastohydrodynamic, boundary, mixed lubrication, extreme pressure regimes, and the like.

The lubricant compositions of this disclosure provide advantaged lubricant electrical conductivity control, including advantaged oxidation stability, deposit control and corrosion inhibition, performance in electric vehicle powertrains under a range of lubrication contact pressures, from 1 MPas to greater than 10 GPas, preferably greater than 10 MPas, more preferably greater than 100 MPas, even more preferably greater than 300 MPas. Under certain circumstances, the lubricant compositions of this disclosure provide advantaged lubricant electrical conductivity control, including advantaged oxidation stability, deposit control and corrosion inhibition, performance in electric vehicle powertrains at greater than 0.5 GPas, often at greater than 1 GPas, sometimes greater than 2 GPas, under selected circumstances greater than 5 GPas.

Further, the lubricant compositions of this disclosure provide advantaged lubricant electrical conductivity control, including advantaged oxidation stability, deposit control and corrosion inhibition, performance on lubricated surfaces of electric vehicle powertrains that include, for example, the following: metals, metal alloys, non-metals, non-metal alloys, mixed carbon-metal composites and alloys, mixed carbon-nonmetal composites and alloys, ferrous metals, ferrous composites and alloys, non-ferrous metals, non-ferrous composites and alloys, titanium, titanium composites and alloys, aluminum, aluminum composites and alloys, magnesium, magnesium composites and alloys, ion-implanted metals and alloys, plasma modified surfaces; surface modified materials; coatings; mono-layer, multi-layer, and gradient layered coatings; honed surfaces; polished surfaces; etched surfaces; textured surfaces; micro and nano structures on textured surfaces; super-finished surfaces; diamond-like carbon (DLC), DLC with high-hydrogen content, DLC with moderate hydrogen content, DLC with low-hydrogen content, DLC with near-zero hydrogen content, DLC composites, DLC-metal compositions and composites, DLC-nonmetal compositions and composites; ceramics, ceramic oxides, ceramic nitrides, FeN, CrN, ceramic carbides, mixed ceramic compositions, cermets, and the like; polymers, thermoplastic polymers, engineered polymers, polymer blends, polymer alloys, polymer composites; materials compositions and composites containing dry lubricants, that include, for example, graphite, carbon, molybdenum, molybdenum disulfide, polytetrafluoroethylene, polyperfluoropropylene, polyperfluoroalkylethers, and the like; super hydrophobic surfaces; super hydrophilic surfaces; self-healing surfaces; surfaces derived from 3-D printing or additive manufacturing techniques, which may be additionally used as-manufactured, or used with post-printing surface finishing, or used with post-printing surface coating.

Still further, the lubricant compositions of this disclosure provide advantaged lubricant electrical conductivity control, including advantaged oxidation stability, deposit control and corrosion inhibition, performance in electric vehicle powertrains with the one or more lubricating oil additives at effective concentration ranges and at effective ratios in accordance with this disclosure.

As used herein, electrical conductivity is determined in accordance with ASTM D2624 (modified), using Model 1153 Digital Conductivity Meter. Dielectric constant measurements were performed using ASTM D924 and TEC FPP8 800. Kinematic viscosity is determined by ASTM D445, total acid number (TAN) is determined by ASTM D974, metals content is determined by ASTM D6376, active sulfur content is determined by ASTM D129, viscosity index (VI) is determined by ASTM D2270, density is determined by ASTM D4052, and specific heat capacity is determined by ASTM D1269.

In an embodiment, the lubricating oils of this disclosure have an electrical conductivity of greater than about 10 pS/m, of greater than about 50 pS/m, or greater than about 100 pS/m, or greater than about 300 pS/m, or greater than about 600 pS/m, or greater than about 1,000 pS/m, or greater than about 2,000 pS/m, or greater than about 3,000 pS/m, or greater than about 4,000 pS/m, or greater than about 5,000 pS/m, or greater than about 6,000 pS/m, or greater than about 8,000 pS/m, or greater than about 10,000 pS/m, or greater than about 15,000 pS/m, or greater than about 20,000 pS/m. In another embodiment, the lubricating oils of this disclosure have an electrical conductivity from about 10 pS/m to about 20,000 pS/m, or from about 50 pS/m to about 19,000 pS/m, or from about 100 pS/m to about 18,000 pS/m, or from about 1,000 pS/m to about 18,000 pS/m, or from about 200 pS/m to about 17,000 pS/m, or 200 pS/m to about 16,000 pS/m, or from about 400 pS/m to about 16,000 pS/m, or from about 1,000 pS/m to about 16,000 pS/m, or from about 500 pS/m to about 15,000 pS/m, or from about 600 pS/m to about 14,000 pS/m, or from about 1,000 pS/m to about 14,000 pS/m, or from about 700 pS/m to about 13,000 pS/m, or from about 800 pS/m to about 12,000 pS/m, or from about 1,000 pS/m to about 12,000 pS/m, or from about 900 pS/m to about 11,000 pS/m, or from about 1,000 pS/m to about 10,000 pS/m, or from about 1,000 pS/m to about 8000 pS/m, or from about 1,000 pS/m to about 6,000 pS/m.

In an embodiment, the lubricating oils of this disclosure have a dielectric constant from about 1.6 to about 3.6, or from about 1.8 to about 3.5, or from about 2 to about 3.4, or from about 2.1 to about 3.2, or from about 2.2 to about 3, or from about 2.2 to about 2.8, or from about 2.2 to about 2.7, or from about 2.2 to 2.6, or about 2.2 to 2.5.

In an embodiment, the lubricating oils of this disclosure have a ratio of conductivity-to-dielectric constant equal to or greater than about 1,000, or greater than about 1,200, or greater than about 1,400, or greater than about 1,600, or greater than about 1,800, or greater than about 2,000, or greater than about 2,500, or greater than about 3,000, or greater than about 4,000, or greater than about 5,000, or greater than about 6,000, or greater than about 7,000, or greater than about 8,000, or greater than about 10,000. In another embodiment, the lubricating oils of this disclosure have a ratio of conductivity-to-dielectric constant from about 1,000 to about 10,000, or about 1,200 to about 9,000, or about 1,400 to about 8,000, or about 1,600 to about 7,000, or about 1,800 to about 6,000, or about 1,800 to about 5,000, or about 1,800 to about 4,000.

In an embodiment, the lubricating oils of this disclosure have a kinematic viscosity at 100° C. from about 2 cSt to about 20 cSt, or from about 3 cSt to about 18 cSt, or from about 3 cSt to about 14 cSt, or from about 3 cSt to about 10 cSt, or from about 4 cSt to about 16 cSt, or from about 5 cSt to about 14 cSt, or from about 6 cSt to about 12 cSt, or from about 8 cSt to about 12 cSt.

In an embodiment, the lubricating oils of this disclosure have a total acid number (TAN) less than about 3, or less than about 2.8, or less than about 2.6, or less than about 2.4, or less than about 2.2, or less than about 2, or less than about 1.8, or less than about 1.6, or less than about 1.4, or less than about 1.2, or less than about 1, or less than about 0.8, or less than about 0.6, or less than about 0.4, or less than about 0.2.

In an embodiment, the lubricating oils of this disclosure have less than about 200 ppm active sulfur, or less than about 100 ppm active sulfur, or less than about 75 ppm active sulfur, or less than about 50 ppm active sulfur, or less than about 25 ppm active sulfur, or less than about 10 ppm active sulfur, or no sulfur.

As used herein, active sulfur is the type of sulfur that reacts with surfaces at low temperatures and is corrosive to such surfaces, especially yellow metals (e.g., brass, bronze, copper, and the like). Active sulfur is chemically aggressive, and with yellow metals being softer than steel, they can begin to pit and form spalls due to this chemical attack. Active sulfur, when in contact with copper along with the presence of heat, forms copper sulfide. This simple chemical reaction can have devastating repercussions on the reliability of electric vehicle powertrains. In extreme pressure situations, copper disulfide can be formed. Both of these crystalline forms of copper are very hard and can cause abrasive damage to powertrain surfaces. In contrast, inactive sulfur only reacts with surfaces at high temperatures.

In an embodiment, the lubricating oils of this disclosure have a viscosity index (VI) greater than about 50, or greater than about 60, or greater than about 70, or greater than about 80, or greater than about 90, or greater than about 100, or greater than about 110, or greater than about 120.

In an embodiment, the lubricating oils of this disclosure have a finished lubricant density of greater than about 0.8 g/mL, or greater than about 0.82 g/mL, or greater than about 0.84 g/mL, or greater than about 0.86 g/mL, or greater than about 0.88 g/mL, or greater than about 0.9 g/mL, or greater than about 0.92 g/mL, or greater than about 0.94 g/mL, or greater than about 0.96 g/mL, or greater than about 0.98 g/mL, or greater than about 1.0 g/mL. In another embodiment, the lubricating oils of this disclosure have a finished lubricant density of from about 0.8 g/mL to about 1.2 g/mL, or from about 0.81 g/mL to about 1.0 g/mL, or from about 0.82 g/mL to about 0.96 g/mL, or from about 0.83 g/mL to about 0.92 g/mL, or from about 0.84 g/mL to about 0.9 g/mL.

In an embodiment, the lubricating oils of this disclosure have a finished lube a specific heat capacity of greater than about 1.9 kJ/kg K, 2.0 kJ/kg K, or greater than about 2.1 kJ/kg K, or greater than about 2.2 kJ/kg K, or greater than about 2.3 kJ/kg K, or greater than about 2.4 kJ/kg K, or greater than about 2.5 kJ/kg K, or greater than about 2.7 kJ/kg K, or greater than about 2.9 kJ/kg K, or greater than about 3.1 kJ/kg K, or greater than about 3.3 kJ/kg K, or greater than about 3.5 kJ/kg K.

In an embodiment, the lubricating oils of this disclosure may encompass solid or semi-solid lubricants, such as for example greases. Also, in an embodiment, the lubricating oils of this disclosure have an operating temperature range of from about 75° C. to about 110° C.

Dielectric breakdown is another important property of the lubricating oils of this disclosure. Dielectric breakdown is the electrical stress that a lubricating oil can withstand without breakdown. Dielectric breakdown is determined by ASTM D877. The voltage at which breakdown occurs (i.e., a spark passing between electrodes) is the test result. The lubricating oils of this disclosure have dielectric breakdown properties sufficient to be safely and efficiently used in electric vehicle powertrains.

### Lubricating Oil Base Stocks and Cobase Stocks

A wide range of lubricating base oils is known in the art. Lubricating base oils that are useful in the present disclosure are natural oils, mineral oils and synthetic oils, and unconventional oils (or mixtures thereof) can be used unrefined, refined, or rerefined (the latter is also known as reclaimed or reprocessed oil). Unrefined oils are those obtained directly from a natural or synthetic source and used without added purification. These include shale oil obtained directly from retorting operations, petroleum oil obtained directly from primary distillation, and ester oil obtained directly from an esterification process. Refined oils are similar to the oils discussed for unrefined oils except refined oils are subjected to one or more purification steps to improve at least one lubricating oil property. One skilled in the art is familiar with many purification processes. These processes include solvent extraction, secondary distillation, acid extraction, base extraction, filtration, and percolation. Rerefined oils are obtained by processes analogous to refined oils but using an oil that has been previously used as a feed stock.

Groups I, II, III, IV and V are broad base oil stock categories developed and defined by the American Petroleum Institute (API Publication 1509; www.API.org) to create guidelines for lubricant base oils. Group I base stocks have a viscosity index of between about 80 to 120 and contain greater than about 0.03% sulfur and/or less than about 90% saturates. Group II base stocks have a viscosity index of between about 80 to 120, and contain less than or equal to about 0.03% sulfur and greater than or equal to about 90% saturates. Group III stocks have a viscosity index greater than about 120 and contain less than or equal to about 0.03% sulfur and greater than about 90% saturates. Group IV includes polyalphaolefins (PAO). Group V base stock includes base stocks not included in Groups I-IV. The table below summarizes properties of each of these five groups. A base stock is typically defined as one specifically characterized fluid of lubricating viscosity. A base oil is typically defined as one or more base stocks used in combination as a fluid of lubricating viscosity.

| | Base Oil Properties | | |
|---|---|---|---|
| | Saturates | Sulfur | Viscosity Index |
| Group I | <90 and/or | >0.03% and | ≥80 and <120 |
| Group II | ≥90 and | ≤0.03% and | ≥80 and <120 |
| Group III | ≥90 and | ≤0.03% and | ≥120 |

| | |
|---|---|
| Group IV | polyalphaolefins (PAO) |
| Group V | All other base oil stocks not included in Groups I, II, III or IV |

Natural oils include animal oils, vegetable oils (castor oil and lard oil, for example), and mineral oils. Animal and vegetable oils possessing favorable thermal oxidative stability can be used. Of the natural oils, mineral oils are preferred. Mineral oils vary widely as to their crude source, for example, as to whether they are paraffinic, naphthenic, or mixed paraffinic-naphthenic. Oils derived from coal or shale are also useful. Natural oils vary also as to the method used for their production and purification, for example, their distillation range and whether they are straight run or cracked, hydrorefined, or solvent extracted.

Group II and/or Group III hydroprocessed or hydrocracked base stocks, including synthetic oils such as alkyl aromatics and synthetic esters are also well known base stock oils. High-quality Group II and Group III hydroprocessed or hydrocracked hydrocarbon base stocks (which may be known respectively as Group II+ and Group III+) are also well known as useful base stock oils. For example, ExxonMobil EHC™ base stocks are Group II basestocks useful in the instant invention.

Synthetic oils include hydrocarbon oil. Hydrocarbon oils include oils such as polymerized and interpolymerized olefins (polybutylenes, polypropylenes, propylene isobutylene copolymers, ethylene-olefin copolymers, and ethylene-alphaolefin copolymers, for example). Polyalphaolefin (PAO) oil base stocks are commonly used synthetic hydrocarbon oil. By way of example, PAOs derived from C₈, C₁₀, C₁₂, C₁₄ olefins or mixtures thereof may be utilized. See U.S. Pat. Nos. 4,956,122; 4,827,064; and 4,827,073.

The number average molecular weights of the PAOs, which are known materials and generally available on a major commercial scale from suppliers such as ExxonMobil Chemical Company, Chevron Phillips Chemical Company, BP, and others, typically vary from about 250 to about 3,000, although PAO's may be made in viscosities up to about 150 cSt (100° C.). The PAOs are typically comprised of relatively low molecular weight hydrogenated polymers or oligomers of alphaolefins which include, but are not limited to, C₂ to about C₃₂ alphaolefins with the C₈ to about C₁₆ alphaolefins, such as 1-octene, 1-decene, 1-dodecene and the like, being preferred. The preferred polyalphaolefins are poly-1-octene, poly-1-decene and poly-1-dodecene and mixtures thereof and mixed olefin-derived polyolefins. However, the dimers of higher olefins in the range of C₁₄ to C₁₈ may be used to provide low viscosity base stocks of acceptably low volatility. Depending on the viscosity grade and the starting oligomer, the PAOs may be predominantly trimers and tetramers of the starting olefins, with minor amounts of the higher oligomers, having a viscosity range of 1.5 to 12 cSt. PAO fluids of particular use may include 3.0 cSt, 3.4 cSt, and/or 3.6 cSt and combinations thereof. Mixtures of PAO fluids having a viscosity range of 1.5 to approximately 150 cSt or more may be used if desired.

The PAO fluids may be conveniently made by the polymerization of an alphaolefin in the presence of a polymerization catalyst such as the Friedel-Crafts catalysts including, for example, aluminum trichloride, boron trifluoride or complexes of boron trifluoride with water, alcohols such as ethanol, propanol or butanol, carboxylic acids or esters such as ethyl acetate or ethyl propionate. For example the methods disclosed by U.S. Pat. Nos. 4,149,178 or 3,382,291 may be conveniently used herein. Other descriptions of PAO synthesis are found in the following U.S. Pat. Nos. 3,742,082; 3,769,363; 3,876,720; 4,239,930; 4,367,352; 4,413,156; 4,434,408; 4,910,355; 4,956,122; and 5,068,487. The dimers of the C₁₄ to C₁₈ olefins are described in U.S. Pat. No. 4,218,330.

Other useful lubricant oil base stocks include wax isomerate base stocks and base oils, comprising hydroisomerized waxy stocks (e.g. waxy stocks such as gas oils, slack waxes, fuels hydrocracker bottoms, etc.), hydroisomerized Fischer-Tropsch waxes, Gas-to-Liquids (GTL) base stocks and base oils, and other wax isomerate hydroisomerized base stocks and base oils, or mixtures thereof. Fischer-Tropsch waxes, the high boiling point residues of Fischer-Tropsch synthesis, are highly paraffinic hydrocarbons with very low sulfur content. The hydroprocessing used for the production of such base stocks may use an amorphous hydrocracking/hydroisomerization catalyst, such as one of the specialized lube hydrocracking (LHDC) catalysts or a crystalline hydrocracking/hydroisomerization catalyst, preferably a zeolitic catalyst. For example, one useful catalyst is ZSM-48 as described in U.S. Pat. No. 5,075,269, the disclosure of which is incorporated herein by reference in its entirety. Processes for making hydrocracked/hydroisomerized distillates and hydrocracked/hydroisomerized waxes are described, for example, in U.S. Pat. Nos. 2,817,693; 4,975,177; 4,921,594 and 4,897,178 as well as in British Patent Nos. 1,429,494; 1,350,257; 1,440,230 and 1,390,359. Each of the aforementioned patents is incorporated herein in their entirety. Particularly favorable processes are described in European Patent Application Nos. 464546 and 464547, also incorporated herein by reference. Processes using Fischer-Tropsch wax feeds are described in U.S. Pat. Nos. 4,594,172 and 4,943,672, the disclosures of which are incorporated herein by reference in their entirety.

Gas-to-Liquids (GTL) base oils, Fischer-Tropsch wax derived base oils, and other wax-derived hydroisomerized (wax isomerate) base oils be advantageously used in the instant disclosure, and may have useful kinematic viscosities at 100° C. of about 3 cSt to about 50 cSt, preferably about 3 cSt to about 30 cSt, more preferably about 3.5 cSt to about 25 cSt, as exemplified by GTL 4 with kinematic viscosity of about 4.0 cSt at 100° C. and a viscosity index of about 141. These Gas-to-Liquids (GTL) base oils, Fischer-Tropsch wax derived base oils, and other wax-derived hydroisomerized base oils may have useful pour points of about −20° C. or lower, and under some conditions may have advantageous pour points of about −25° C. or lower, with useful pour points of about −30° C. to about −40° C. or lower. Useful compositions of Gas-to-Liquids (GTL) base oils, Fischer-Tropsch wax derived base oils, and wax-derived hydroisomerized base oils are recited in U.S. Pat. Nos. 6,080,301; 6,090,989, and 6,165,949 for example, and are incorporated herein in their entirety by reference.

The hydrocarbyl aromatics can be used as a base oil or base oil component and can be any hydrocarbyl molecule that contains at least about 5% of its weight derived from an aromatic moiety such as a benzenoid moiety or naphthenoid moiety, or their derivatives. These hydrocarbyl aromatics include alkyl benzenes, alkyl naphthalenes, alkyl diphenyl oxides, alkyl naphthols, alkyl diphenyl sulfides, alkylated bis-phenol A, alkylated thiodiphenol, and the like. The aromatic can be mono-alkylated, dialkylated, polyalkylated, and the like. The aromatic can be mono- or poly-functionalized. The hydrocarbyl groups can also be comprised of mixtures of alkyl groups, alkenyl groups, alkynyl, cycloalkyl groups, cycloalkenyl groups and other related hydrocarbyl groups. The hydrocarbyl groups can range from about C₆ up to about C₆₀ with a range of about C₈ to about C₂₀ often being preferred. A mixture of hydrocarbyl groups is often preferred, and up to about three such substituents may be present. The hydrocarbyl group can optionally contain sulfur, oxygen, and/or nitrogen containing substituents. The aromatic group can also be derived from natural (petroleum) sources, provided at least about 5% of the molecule is comprised of an above-type aromatic moiety. Viscosities at 100° C. of approximately 3 cSt to about 50 cSt are preferred, with viscosities of approximately 3.4 cSt to about 20 cSt often being more preferred for the hydrocarbyl aromatic component. In one embodiment, an alkyl naphthalene where the alkyl group is primarily comprised of 1-hexadecene is used. Other alkylates of aromatics can be advantageously used. Naphthalene or methyl naphthalene, for example, can be alkylated with olefins such as octene, decene, dodecene, tetradecene or higher, mixtures of similar olefins, and the like. Useful concentrations of hydrocarbyl aromatic in a lubricant oil composition can be about 2% to about 25%, preferably about 4% to about 20%, and more preferably about 4% to about 15%, depending on the application.

Alkylated aromatics such as the hydrocarbyl aromatics of the present disclosure may be produced by well-known Friedel-Crafts alkylation of aromatic compounds. See Friedel-Crafts and Related Reactions, Olah, G. A. (ed.), Inter-science Publishers, New York, 1963. For example, an aromatic compound, such as benzene or naphthalene, is alkylated by an olefin, alkyl halide or alcohol in the presence of a Friedel-Crafts catalyst. See Friedel-Crafts and Related Reactions, Vol. 2, part 1, chapters 14, 17, and 18, See Olah, G. A. (ed.), Inter-science Publishers, New York, 1964. Many homogeneous or heterogeneous, solid catalysts are known to one skilled in the art. The choice of catalyst depends on the reactivity of the starting materials and product quality requirements. For example, strong acids such as AlCl₃, BF₃, or HF may be used. In some cases, milder catalysts such as FeCl₃ or SnCl₄ are preferred. Newer alkylation technology uses zeolites or solid super acids.

Esters comprise a useful base stock. Additive solvency and seal compatibility characteristics may be secured by the use of esters such as the esters of dibasic acids with monoalkanols and the polyol esters of monocarboxylic acids. Esters of the former type include, for example, the esters of dicarboxylic acids such as phthalic acid, succinic acid, alkyl succinic acid, alkenyl succinic acid, maleic acid, azelaic acid, suberic acid, sebacic acid, fumaric acid, adipic acid, linoleic acid dimer, malonic acid, alkyl malonic acid, alkenyl malonic acid, etc., with a variety of alcohols such as butyl alcohol, hexyl alcohol, dodecyl alcohol, 2-ethylhexyl alcohol, etc. Specific examples of these types of esters include dibutyl adipate, di(2-ethylhexyl) sebacate, di-n-hexyl fumarate, dioctyl sebacate, diisooctyl azelate, diisodecyl azelate, di(2-ethylhexyl) azelate, dioctyl phthalate, didecyl phthalate, dieicosyl sebacate, etc.

Particularly useful synthetic esters are those which are obtained by reacting one or more polyhydric alcohols, preferably the hindered polyols (such as the neopentyl polyols, e.g., neopentyl glycol, trimethylol ethane, 2-methyl-2-propyl-1,3-propanediol, trimethylol propane, pentaerythritol and dipentaerythritol) with alkanoic acids containing at least about 4 carbon atoms, preferably C₅ to C₃₀ acids such as saturated straight chain fatty acids including caprylic acid, capric acid, lauric acid, myristic acid, palmitic acid, stearic acid, arachic acid, and behenic acid, or the corresponding branched chain fatty acids or unsaturated fatty acids such as oleic acid, or mixtures of any of these materials.

Suitable synthetic ester components include the esters of trimethylol propane, trimethylol butane, trimethylol ethane, pentaerythritol and/or dipentaerythritol with one or more monocarboxylic acids containing from about 5 to about 10 carbon atoms. These esters are widely available commercially, for example, the Mobil P-41 and P-51 esters of ExxonMobil Chemical Company.

Also useful are esters derived from renewable material such as coconut, palm, rapeseed, soy, sunflower and the like. These esters may be monoesters, di-esters, polyol esters, complex esters, or mixtures thereof. These esters are widely available commercially, for example, the Mobil P-51 ester of ExxonMobil Chemical Company.

Engine oil compositions containing renewable esters are included in this disclosure. For such compositions, the renewable content of the ester is typically greater than about 70 weight percent, preferably more than about 80 weight percent and most preferably more than about 90 weight percent.

Other useful fluids of lubricating viscosity include non-conventional or unconventional base stocks that have been processed, preferably catalytically, or synthesized to provide high performance lubrication characteristics.

Useful base stock fluids also include polyethers, polyglycols, polyalkylene glycols (PAG), polypropanols, polyalkylene propanols, polypropylene oxides, polybutylene oxides, polytetrahydrofurans, polyalkylene tetrahydrofurans, and analogues of polyether-type fluids, where such polyethers may be uncapped, mono-capped, di-capped, or multi-capped, with functional groups which may include for example ethers, esters, ketones, urethanes, aromatics, heteroaromatics, hydrocarbyl moieties, etc. In addition, useful polyether-type base stock fluids include oil-soluble or hydrocarbon-soluble versions of polyethers or PAGs or polyalkylene ethers or polyalkylene oxides.

Non-conventional or unconventional base stocks/base oils include one or more of a mixture of base stock(s) derived from one or more Gas-to-Liquids (GTL) materials, as well as isomerate/isodewaxate base stock(s) derived from natural wax or waxy feeds, mineral and or non-mineral oil waxy feed stocks such as slack waxes, natural waxes, and waxy stocks such as gas oils, waxy fuels hydrocracker bottoms, waxy raffinate, hydrocrackate, thermal crackates, or other mineral, mineral oil, or even non-petroleum oil derived waxy materials such as waxy materials received from coal liquefaction or shale oil, and mixtures of such base stocks.

GTL materials are materials that are derived via one or more synthesis, combination, transformation, rearrangement, and/or degradation/deconstructive processes from gaseous carbon-containing compounds, hydrogen-containing compounds and/or elements as feed stocks such as hydrogen, carbon dioxide, carbon monoxide, water, methane, ethane, ethylene, acetylene, propane, propylene, propyne, butane, butylenes, and butynes. GTL base stocks and/or base oils are GTL materials of lubricating viscosity that are generally derived from hydrocarbons; for example, waxy synthesized hydrocarbons, that are themselves derived from simpler gaseous carbon-containing compounds, hydrogen-containing compounds and/or elements as feed stocks. GTL base stock(s) and/or base oil(s) include oils boiling in the lube oil boiling range (1) separated/fractionated from synthesized GTL materials such as, for example, by distillation and subsequently subjected to a final wax processing step which involves either or both of a catalytic dewaxing process, or a solvent dewaxing process, to produce lube oils of reduced/low pour point; (2) synthesized wax isomerates, comprising, for example, hydrodewaxed or hydroisomerized cat and/or solvent dewaxed synthesized wax or waxy hydrocarbons; (3) hydrodewaxed or hydroisomerized cat and/or solvent dewaxed Fischer-Tropsch (F-T) material (i.e., hydrocarbons, waxy hydrocarbons, waxes and possible analogous oxygenates); preferably hydrodewaxed or hydroisomerized/followed by cat and/or solvent dewaxing dewaxed F-T waxy hydrocarbons, or hydrodewaxed or hydroisomerized/followed by cat (or solvent) dewaxing dewaxed, F-T waxes, or mixtures thereof.

GTL base stock(s) and/or base oil(s) derived from GTL materials, especially, hydrodewaxed or hydroisomerized/followed by cat and/or solvent dewaxed wax or waxy feed, preferably F-T material derived base stock(s) and/or base oil(s), are characterized typically as having kinematic viscosities at 100° C. of from about 2 mm²/s to about 50 mm²/s (ASTM D445). They are further characterized typically as having pour points of −5° C. to about −40° C. or lower (ASTM D97). They are also characterized typically as having viscosity indices of about 80 to about 140 or greater (ASTM D2270).

In addition, the GTL base stock(s) and/or base oil(s) are typically highly paraffinic (>90% saturates), and may contain mixtures of monocycloparaffins and multicycloparaffins in combination with non-cyclic isoparaffins. The ratio of the naphthenic (i.e., cycloparaffin) content in such combinations varies with the catalyst and temperature used. Further, GTL base stock(s) and/or base oil(s) typically have very low sulfur and nitrogen content, generally containing less than about 10 ppm, and more typically less than about 5 ppm of each of these elements. The sulfur and nitrogen content of GTL base stock(s) and/or base oil(s) obtained from F-T material, especially F-T wax, is essentially nil. In addition, the absence of phosphorous and aromatics make this materially especially suitable for the formulating of low SAP products.

The term GTL base stock and/or base oil and/or wax isomerate base stock and/or base oil is to be understood as embracing individual fractions of such materials of wide viscosity range as recovered in the production process, mixtures of two or more of such fractions, as well as mixtures of one or two or more low viscosity fractions with one, two or more higher viscosity fractions to produce a blend wherein the blend exhibits a target kinematic viscosity.

The GTL material, from which the GTL base stock(s) and/or base oil(s) is/are derived is preferably an F-T material (i.e., hydrocarbons, waxy hydrocarbons, wax).

Base oils for use in the lubricating oils useful in the present disclosure are any of the variety of oils corresponding to API Group I, Group II, Group III, Group IV, and Group V oils, and mixtures thereof, preferably API Group II, Group III, Group IV, and Group V oils, and mixtures thereof, more preferably Group III, Group IV, and Group V base oils, and mixtures thereof. Highly paraffinic base oils can be used to advantage in the lubricating oils useful in the present disclosure. Minor quantities of Group I stock, such as the amount used to dilute additives for blending into lube oil products, can also be used. Even in regard to the Group II stocks, it is preferred that the Group II stock be in the higher quality range associated with that stock, i.e. a Group II stock having a viscosity index in the range 100<VI<120.

The base oil constitutes the major component of the engine oil lubricant composition of the present disclosure and typically is present in an amount ranging from about 50 to about 99 weight percent, preferably from about 70 to about 95 weight percent, and more preferably from about 85 to about 95 weight percent, based on the total weight of the composition. The base oil may be selected from any of the synthetic or natural oils typically used as crankcase lubricating oils for spark-ignited and compression-ignited engines. The base oil conveniently has a kinematic viscosity, according to ASTM standards, of about 2.5 cSt to about 12 cSt (or mm²/s) at 100° C. and preferably of about 2.5 cSt to about 9 cSt (or mm²/s) at 100° C. Mixtures of synthetic and natural base oils may be used if desired. Bi-modal mixtures of Group I, II, III, IV, and/or V base stocks may be used if desired.

### Antioxidants

The lubricating oil compositions include at least one antioxidant. Antioxidants retard the oxidative degradation of base oils during service. Such degradation may result in deposits on metal surfaces, the presence of sludge, or a viscosity increase in the lubricant. One skilled in the art knows a wide variety of oxidation inhibitors that are useful in lubricating oil compositions. See, Klamann in Lubricants and Related Products, op cite, and U.S. Pat. Nos. 4,798,684 and 5,084,197, for example.

Illustrative antioxidants include sterically hindered alkyl phenols such as 2,6-di-tert-butylphenol, 2,6-di-tert-butyl-p-cresol and 2,6-di-tert-butyl-4-(2-octyl-3-propanoic) phenol; N,N-di(alkylphenyl) amines; and alkylated phenylenediamines.

The antioxidant may be a hindered phenolic antioxidant such as butylated hydroxytoluene, suitably present in an amount of 0.01 to 5%, preferably 0.4 to 0.8%, by weight of the lubricant composition. Alternatively, or in addition, the antioxidant may comprise an aromatic amine antioxidant such as mono-octylphenylalphanapthyl amine or p,p-dioctyldiphenylamine, used singly or in admixture. The amine antioxidant component is suitably present in a range of from 0.01 to 5% by weight of the lubricant composition, more preferably 0.5 to 1.5%.

Useful antioxidants include hindered phenols. These phenolic antioxidants may be ashless (metal-free) phenolic compounds or neutral or basic metal salts of certain phenolic compounds. Typical phenolic antioxidant compounds are the hindered phenolics which are the ones which contain a sterically hindered hydroxyl group, and these include those derivatives of dihydroxy aryl compounds in which the hydroxyl groups are in the o- or p-position to each other. Typical phenolic antioxidants include the hindered phenols substituted with C₆+ alkyl groups and the alkylene coupled derivatives of these hindered phenols. Examples of phenolic materials of this type 2-t-butyl-4-heptyl phenol; 2-t-butyl-4-octyl phenol; 2-t-butyl-4-dodecyl phenol; 2,6-di-t-butyl-4-heptyl phenol; 2,6-di-t-butyl-4-dodecyl phenol; 2-methyl-6-t-butyl-4-heptyl phenol; and 2-methyl-6-t-butyl-4-dodecyl phenol. Other useful hindered mono-phenolic antioxidants may include for example hindered 2,6-di-alkyl-phenolic proprionic ester derivatives. Bis-phenolic antioxidants may also be advantageously used in combination with the instant disclosure. Examples of ortho-coupled phenols include: 2,2′-bis(4-heptyl-6-t-butyl-phenol); 2,2′-bis(4-octyl-6-t-butyl-phenol); and 2,2′-bis(4-dodecyl-6-t-butyl-phenol). Para-coupled bisphenols include for example 4,4′-bis(2,6-di-t-butyl phenol) and 4,4′-methylene-bis(2,6-di-t-butyl phenol).

Other illustrative phenolic antioxidants include sulfurized and non-sulfurized phenolic antioxidants. The terms “phenolic type” or “phenolic antioxidant” used herein includes compounds having one or more than one hydroxyl group bound to an aromatic ring which may itself be mononuclear, e.g., benzyl, or poly-nuclear, e.g., naphthyl and Spiro aromatic compounds. Thus “phenol type” includes phenol per se, catechol, resorcinol, hydroquinone, naphthol, etc., as well as alkyl or alkenyl and sulfurized alkyl or alkenyl derivatives thereof, and bisphenol type compounds including such bi-phenol compounds linked by alkylene bridges sulfuric bridges or oxygen bridges. Alkyl phenols include mono- and poly-alkyl or alkenyl phenols, the alkyl or alkenyl group containing from 3-100 carbons, preferably 4 to 50 carbons and sulfurized derivatives thereof, the number of alkyl or alkenyl groups present in the aromatic ring ranging from 1 to up to the available unsatisfied valences of the aromatic ring remaining after counting the number of hydroxyl groups bound to the aromatic ring.

Generally, therefore, the phenolic antioxidant may be represented by the general formula:

(R)ₓ—Ar—(OH)_{y}

where Ar is selected from the group consisting of:

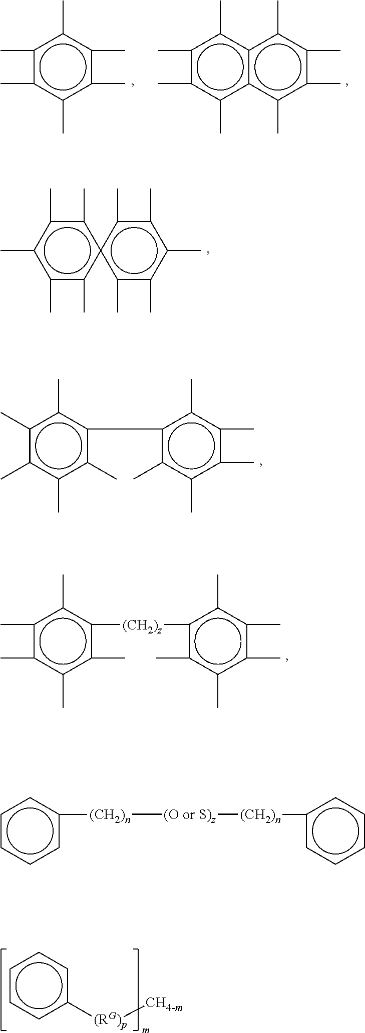

wherein R is a C₃-C₁₀₀ alkyl or alkenyl group, a sulfur substituted alkyl or alkenyl group, preferably a C₄-C₅₀ alkyl or alkenyl group or sulfur substituted alkyl or alkenyl group, more preferably C₃-C₁₀₀ alkyl or sulfur substituted alkyl group, most preferably a C₄-C₅₀ alkyl group, R^{g} is a C₁-C₁₀₀ alkylene or sulfur substituted alkylene group, preferably a C₂-C₅₀ alkylene or sulfur substituted alkylene group, more preferably a C₂-C₂₀ alkylene or sulfur substituted alkylene group, y is at least 1 to up to the available valences of Ar, x ranges from 0 to up to the available valances of Ar-y, z ranges from 1 to 10, n ranges from 0 to 20, and m is 0 to 4 and p is 0 or 1, preferably y ranges from 1 to 3, x ranges from 0 to 3, z ranges from 1 to 4 and n ranges from 0 to 5, and p is 0.

Preferred phenolic antioxidant compounds are the hindered phenolics and phenolic esters which contain a sterically hindered hydroxyl group, and these include those derivatives of dihydroxy aryl compounds in which the hydroxyl groups are in the o- or p-position to each other. Typical phenolic antioxidants include the hindered phenols substituted with C.sub.1+ alkyl groups and the alkylene coupled derivatives of these hindered phenols. Examples of phenolic materials of this type 2-t-butyl-4-heptyl phenol; 2-t-butyl-4-octyl phenol; 2-t-butyl-4-dodecyl phenol; 2,6-di-t-butyl-4-heptyl phenol; 2,6-di-t-butyl-4-dodecyl phenol; 2-methyl-6-t-butyl-4-heptyl phenol; 2-methyl-6-t-butyl-4-dodecyl phenol; 2,6-di-t-butyl-4 methyl phenol; 2,6-di-t-butyl-4-ethyl phenol; and 2,6-di-t-butyl 4 alkoxy phenol; and

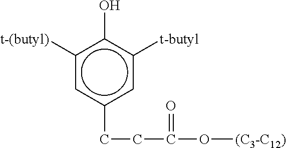

Phenolic type antioxidants are well known in the lubricating industry and commercial examples such as Ethanox™ 1710, Irganox™ 1076, Irganox™ L1035, Irganox™ 1010, Irganox™ L109, Irganox™ L118, Irganox™ L135 and the like are familiar to those skilled in the art. The above is presented only by way of exemplification, not limitation on the type of phenolic antioxidants which can be used.

Other examples of phenol-based antioxidants include 2-t-butylphenol, 2-t-butyl-4-methylphenol, 2-t-butyl-5-methylphenol, 2,4-di-t-butylphenol, 2,4-dimethyl-6-t-butylphenol, 2-t-butyl-4-methoxyphenol, 3-t-butyl-4-methoxyphenol, 2,5-di-t-butylhydroquinone (manufactured by the Kawaguchi Kagaku Co. under trade designation “Antage DBH”), 2,6-di-t-butylphenol and 2,6-di-t-butyl-4-alkylphenols such as 2,6-di-t-butyl-4-methylphenol and 2,6-di-t-butyl-4-ethylphenol; 2,6-di-t-butyl-4-alkoxyphenols such as 2,6-di-t-butyl-4-methoxyphenol and 2,6-di-t-butyl-4-ethoxyphenol, 3,5-di-t-butyl-4-hydroxybenzylmercaptoocty-1 acetate, alkyl-3-(3,5-di-t-butyl-4-hydroxyphenyl)propionates such as n-octyl-3-(3,5-di-t-butyl-4-hydroxyphenyl)propionate (manufactured by the Yoshitomi Seiyaku Co. under the trade designation “Yonox SS”), n-dodecyl-3-(3,5-di-t-butyl-4-hydroxyphenyl)propionate and 2′-ethylhexyl-3-(3,5-di-t-butyl-4-hydroxyphenyl)propionate; 2,6-di-t-butyl-alpha-dimethylamino-p-cresol, 2,2′-methylenebis(4-alkyl-6-t-butylphenol) compounds such as 2,2′-methylenebis(4-methyl-6-t-butylphenol) (manufactured by the Kawaguchi Kagaku Co. under the trade designation “Antage W-400”) and 2,2′-methylenebis(4-ethyl-6-t-butylphenol) (manufactured by the Kawaguchi Kagaku Co. under the trade designation “Antage W-500”); bisphenols such as 4,4′-butylidenebis(3-methyl-6-t-butyl-phenol) (manufactured by the Kawaguchi Kagaku Co. under the trade designation “Antage W-300”), 4,4′-methylenebis(2,6-di-t-butylphenol) (manufactured by Laporte Performance Chemicals under the trade designation “Ionox 220AH”), 4,4′-bis(2,6-di-t-butylphenol), 2,2-(di-p-hydroxyphenyl)propane (Bisphenol A), 2,2-bis(3,5-di-t-butyl-4-hydroxyphenyl)propane, 4,4′-cyclohexylidenebis(2,6-di-t-butylphenol), hexamethylene glycol bis[3, (3,5-di-t-butyl-4-hydroxyphenyl)propionate] (manufactured by the Ciba Specialty Chemicals Co. under the trade designation “Irganox L109”), tri ethylene glycol bis[3-(3-t-butyl-4-hydroxy-y-5-methylphenyl)propionate] (manufactured by the Yoshitomi Seiyaku Co. under the trade designation “Tominox 917”), 2,2′-thio[diethyl-3-(3,5-di-t-butyl-4-hydroxy phenyl)propionate] (manufactured by the Ciba Specialty Chemicals Co. under the trade designation “Irganox L115”), 3,9-bis{1,1-dimethyl-2-[3-(3-t-butyl-4-hydroxy-5-methylphenyl)-propionyloxy] ethyl}2,4,8,10-tetraoxaspiro[5,5]undecane (manufactured by the Sumitomo Kagaku Co. under the trade designation “Sumilizer GA80”) and 4,4′-thiobis(3-methyl-6-t-butylphenol) (manufactured by the Kawaguchi Kagaku Co. under the trade designation “Antage RC”), 2,2′-thiobis(4,6-di-t-butylresorcinol); polyphenols such as tetrakis[methylene-3-(3,5-di-t-butyl-4-hydroxyphenyl)propionato[methane (manufactured by the Ciba Speciality Chemicals Co. under the trade designation “Irganox L101”), 1,1,3-tris(2-methyl-4-hydroxy-5-t-butylphenyl)butane (manufactured by the Yoshitomi Seiyaku Co. under the trade designation “Yoshinox 930”), 1,3,5-trimethyl-2,4,6-tris(3,5-di-t-butyl-4-hydroxybenzyl)benzene (manufactured by Ciba Speciality Chemicals under the trade designation “Irganox 330”), bis[3,3′-bis(4′-hydroxy-3′-t-butylpheny-1)butyric acid] glycol ester, 2-(3′,5′-di-t-butyl-4-hydroxyphenyl)-methyl-4-(2″,4″-di-t-butyl-3″-hydroxyphenyl)methyl-6-t-butylphenol and 2,6-bis(2′-hydroxy-3′-t-butyl-5′-methylbenzyl)-4-methylphenol; and phenol/aldehyde condensates such as the condensates of p-t-butylphenol and formaldehyde and the condensates of p-t-butylphenol and acetaldehyde.

Effective amounts of one or more catalytic antioxidants may also be used. The catalytic antioxidants comprise an effective amount of a) one or more oil soluble polymetal organic compounds; and, effective amounts of b) one or more substituted N,N′-diaryl-o-phenylenediamine compounds or c) one or more hindered phenol compounds; or a combination of both b) and c). Catalytic antioxidants are more fully described in U.S. Pat. No. 8,048,833, herein incorporated by reference in its entirety.

Illustrative aromatic amine antioxidants include phenyl-alpha-naphthyl amine which is described by the following molecular structure:

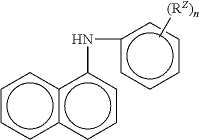

wherein R^{z} is hydrogen or a C₁ to C₁₄ linear or C₃ to C₁₄ branched alkyl group, preferably C₁ to Cm linear or C₃ to Cm branched alkyl group, more preferably linear or branched C₆ to C₈ and n is an integer ranging from 1 to 5 preferably 1. A particular example is Irganox L06.

Other aromatic amine antioxidants include other alkylated and non-alkylated aromatic amines such as aromatic monoamines.

Typical aromatic amines antioxidants have alkyl substituent groups of at least 6 carbon atoms. Examples of aliphatic groups include hexyl, heptyl, octyl, nonyl, and decyl. Generally, the aliphatic groups will not contain more than 14 carbon atoms. The general types of such other additional amine antioxidants which may be present include diphenylamines, phenothiazines, imidodibenzyls and diphenyl phenylene diamines. Mixtures of two or more of such other additional aromatic amines may also be present. Polymeric amine antioxidants can also be used.

The antioxidants or oxidation inhibitors that are useful in lubricant oil compositions of the disclosure are the hindered phenols (e.g., 2,6-di-(t-butyl)phenol); aromatic amines (e.g., alkylated diphenyl amines); alkyl polysulfides; selenides; borates (e.g., epoxide/boric acid reaction products); phosphorodithioic acids, esters and/or salts; and the dithiocarbamate (e.g., zinc dithiocarbamates). In an embodiment, these antioxidants or oxidation inhibitors can be employed at ratios of amine/phenolic from 1:10 to 10:1 of the mixtures preferred.

The antioxidants or oxidation inhibitors that are also useful in lubricant oil compositions of the disclosure are chlorinated aliphatic hydrocarbons such as chlorinated wax; organic sulfides and polysulfides such as benzyl disulfide, bis(chlorobenzyl)disulfide, dibutyl tetrasulfide, sulfurized methyl ester of oleic acid, sulfurized alkylphenol, sulfurized dipentene, and sulfurized terpene; phosphosulfiirized hydrocarbons such as the reaction product of a phosphorus sulfide with turpentine or methyl oleate, phosphorus esters including principally dihydrocarbon and trihydrocarbon phosphites such as dibutyl phosphite, diheptyl phosphite, dicyclohexyl phosphite, pentylphenyl phosphite, dipentylphenyl phosphite, tridecyl phosphite, distearyl phosphite, dimethyl naphthyl phosphite, oleyl 4-pentylphenyl phosphite, polypropylene (molecular weight 500)-substituted phenyl phosphite, diisobutyl-substituted phenyl phosphite; metal thiocarbamates, such as zinc dioctyldithiocarbamate, and barium heptylphenyl dithiocarbamate; Group II metal phosphorodithioates such as zinc dicyclohexylphosphorodithioate, zinc dioctylphosphorodithioate, barium di(heptylphenyl)(phosphorodithioate, cadmium dinonylphosphorodithioate, and the reaction of phosphorus pentasulfide with an equimolar mixture of isopropyl alcohol, 4-methyl-2-pentanol, and n-hexyl alcohol.

Oxidation inhibitors including organic compounds containing sulfur, nitrogen, phosphorus and some alkylphenols are useful additives in the lubricating oil compositions of this disclosure. Two general types of oxidation inhibitors are those that react with the initiators, peroxy radicals, and hydroperoxides to form inactive compounds, and those that decompose these materials to form less active compounds. Examples are hindered (alkylated) phenols, e.g. 6-di(tert-butyl)-4-methyl-phenol[2,6-di(tert-butyl)-p-cresol, DBPC], and aromatic amines, e.g. N-phenyl-alpha-naphthalamine.

Sulfurized alkyl phenols and alkali or alkaline earth metal salts thereof also are useful antioxidants.

Another class of antioxidant used in lubricating oil compositions and which may also be present are oil-soluble copper compounds. Any oil-soluble suitable copper compound may be blended into the lubricating oil. Examples of suitable copper antioxidants include copper dihydrocarbyl thio- or dithio-phosphates and copper salts of carboxylic acid (naturally occurring or synthetic). Other suitable copper salts include copper dithiacarbamates, sulphonates, phenates, and acetylacetonates. Basic, neutral, or acidic copper Cu(I) and or Cu(II) salts derived from alkenyl succinic acids or anhydrides are known to be particularly useful.

A sulfur-containing antioxidant may be any and every antioxidant containing sulfur, for example, including dialkyl thiodipropionates such as dilauryl thiodipropionate and distearyl thiodipropionate, dialkyldithiocarbamic acid derivatives (excluding metal salts), bis(3,5-di-t-butyl-4-hydroxybenzyl)sulfide, mercaptobenzothiazole, reaction products of phosphorus pentoxide and olefins, and dicetyl sulfide. Of these, preferred are dialkyl thiodipropionates such as dilauryl thiodipropionate and distearyl thiodipropionate. The amine-type antioxidant includes, for example, monoalkyldiphenylamines such as monooctyldiphenylamine and monononyldiphenyl amine; dialkyldiphenylamines such as 4,4′-dibutyldiphenylamine, 4,4′-dipentyldiphenylamine, 4,4′-dihexyldiphenylamine, 4,4′-diheptyldiphenylamine, 4,4′-dioctyldiphenylamine and 4,4′-dinonyldiphenylamine; polyalkyldiphenylamines such as tetrabutyldiphenylamine, tetrahexyldiphenylamine, tetraoctyldiphenylamine and tetranonyldiphenylamine; and naphthylamines such as alpha-naphthylamine, phenyl-alpha-naphthylamine, butylphenyl-alpha-naphthylamine, pentylphenyl-alpha-naphthylamine, hexylphenyl-alpha-naphthylamine, heptylphenyl-alpha-naphthylamine, octylphenyl-alpha-naphthyl amine and nonylphenyl-alpha-naphthylamine. Of these, preferred are dialkyldiphenylamines.

Examples of sulfur-based antioxidants include dialkylsulfides such as didodecylsulfide and dioctadecylsulfide; thiodipropionic acid esters such as didodecyl thiodipropionate, dioctadecyl thiodipropionate, dimyristyl thiodipropionate and dodecyloctadecyl thiodipropionate, and 2-mercaptobenzimidazole.

Such antioxidants may be used individually or as mixtures of one or more types of antioxidants, the total amount employed being an amount of about 0.01 to about 5 wt %, preferably 0.1 to about 4.5 wt %, more preferably 0.25 to 3 wt % (on an as-received basis).

### Detergents

The lubricating oil compositions include at least one detergent. Illustrative detergents useful in this disclosure include, for example, alkali metal detergents, alkaline earth metal detergents, or mixtures of one or more alkali metal detergents and one or more alkaline earth metal detergents. A typical detergent is an anionic material that contains a long chain hydrophobic portion of the molecule and a smaller anionic or oleophobic hydrophilic portion of the molecule. The anionic portion of the detergent is typically derived from an organic acid such as a sulfur acid, carboxylic acid (e.g., salicylic acid), phosphorous acid, phenol, or mixtures thereof. The counterion is typically an alkaline earth or alkali metal.

The detergent is preferably a metal salt of an organic or inorganic acid, a metal salt of a phenol, or mixtures thereof. The metal is preferably selected from an alkali metal, an alkaline earth metal, and mixtures thereof. The organic or inorganic acid is selected from an aliphatic organic or inorganic acid, a cycloaliphatic organic or inorganic acid, an aromatic organic or inorganic acid, and mixtures thereof.

The metal is preferably selected from an alkali metal, an alkaline earth metal, and mixtures thereof. More preferably, the metal is selected from calcium (Ca), magnesium (Mg), and mixtures thereof.

The organic acid or inorganic acid is preferably selected from a sulfur acid, a carboxylic acid, a phosphorus acid, and mixtures thereof.

Preferably, the metal salt of an organic or inorganic acid or the metal salt of a phenol comprises calcium phenate, calcium sulfonate, calcium salicylate, magnesium phenate, magnesium sulfonate, magnesium salicylate, and mixtures thereof.

Salts that contain a substantially stochiometric amount of the metal are described as neutral salts and have a total base number (TBN, as measured by ASTM D2896) of from 0 to 80. Many compositions are overbased, containing large amounts of a metal base that is achieved by reacting an excess of a metal compound (a metal hydroxide or oxide, for example) with an acidic gas (such as carbon dioxide). Useful detergents can be neutral, mildly overbased, or highly overbased. These detergents can be used in mixtures of neutral, overbased, highly overbased calcium salicylate, sulfonates, phenates and/or magnesium salicylate, sulfonates, phenates. The TBN ranges can vary from low, medium to high TBN products, including as low as 0 to as high as 600. Preferably the TBN delivered by the detergent is between 1 and 20. More preferably between 1 and 12. Mixtures of low, medium, high TBN can be used, along with mixtures of calcium and magnesium metal based detergents, and including sulfonates, phenates, salicylates, and carboxylates. A detergent mixture with a metal ratio of 1, in conjunction of a detergent with a metal ratio of 2, and as high as a detergent with a metal ratio of 5, can be used. Borated detergents can also be used.

Alkaline earth phenates are another useful class of detergent. These detergents can be made by reacting alkaline earth metal hydroxide or oxide (CaO, Ca(OH)₂, BaO, Ba(OH)₂, MgO, Mg(OH)₂, for example) with an alkyl phenol or sulfurized alkylphenol. Useful alkyl groups include straight chain or branched C₁-C₃₀ alkyl groups, preferably, C₄-C₂₀ or mixtures thereof. Examples of suitable phenols include isobutylphenol, 2-ethylhexylphenol, nonylphenol, dodecyl phenol, and the like. It should be noted that starting alkylphenols may contain more than one alkyl substituent that are each independently straight chain or branched and can be used from 0.5 to 6 weight percent. When a non-sulfurized alkylphenol is used, the sulfurized product may be obtained by methods well known in the art. These methods include heating a mixture of alkylphenol and sulfurizing agent (including elemental sulfur, sulfur halides such as sulfur dichloride, and the like) and then reacting the sulfurized phenol with an alkaline earth metal base.

Metal salts of carboxylic acids are useful detergents. These carboxylic acid detergents may be prepared by reacting a basic metal compound with at least one carboxylic acid and removing free water from the reaction product. Detergents made from salicylic acid are one preferred class of detergents derived from carboxylic acids. Useful salicylates include long chain alkyl salicylates. One useful family of compositions is of the formula

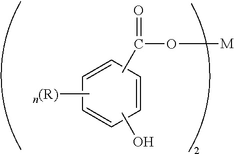

where R is an alkyl group having 1 to about 30 carbon atoms, n is an integer from 1 to 4, and M is an alkaline earth metal. Preferred R groups are alkyl chains of at least C₁₁, preferably C₁₃ or greater. R may be optionally substituted with substituents that do not interfere with the detergent's function. M is preferably, calcium, magnesium, or barium. More preferably, M is calcium.

Hydrocarbyl-substituted salicylic acids may be prepared from phenols by the Kolbe reaction (see U.S. Pat. No. 3,595,791). The metal salts of the hydrocarbyl-substituted salicylic acids may be prepared by double decomposition of a metal salt in a polar solvent such as water or alcohol.

Alkaline earth metal phosphates are also used as detergents and are known in the art.

Detergents may be simple detergents or what is known as hybrid or complex detergents. The latter detergents can provide the properties of two detergents without the need to blend separate materials. See U.S. Pat. No. 6,034,039.

Illustrative detergents include calcium alkylsalicylates, calcium alkylphenates and calcium alkarylsulfonates with alternate metal ions used such as magnesium, barium, or sodium. Examples of the cleaning and dispersing agents which can be used include metal-based detergents such as the neutral and basic alkaline earth metal sulphonates, alkaline earth metal phenates and alkaline earth metal salicylates alkenylsuccinimide and alkenylsuccinimide esters and their borohydrides, phenates, salienius complex detergents and ashless dispersing agents which have been modified with sulfur compounds. These agents can be added and used individually or in the form of mixtures, conveniently in an amount within the range of from 0.01 to 1 part by weight per 100 parts by weight of base oil; these can also be high TBN, low TBN, or mixtures of high/low TBN.

Preferred detergents include calcium sulfonates, magnesium sulfonates, calcium salicylates, magnesium salicylates, calcium phenates, magnesium phenates, and other related components (including borated detergents), and mixtures thereof. Preferred mixtures of detergents include magnesium sulfonate and calcium salicylate, magnesium sulfonate and calcium sulfonate, magnesium sulfonate and calcium phenate, calcium phenate and calcium salicylate, calcium phenate and calcium sulfonate, calcium phenate and magnesium salicylate, calcium phenate and magnesium phenate.

The detergent concentration in the lubricating oils of this disclosure can range from about 0.01 to about 10 weight percent, preferably about 0.1 to 7.5 weight percent, and more preferably from about 0.5 weight percent to about 5 weight percent, based on the total weight of the lubricating oil.

As used herein, the detergent concentrations are given on an “as delivered” basis. Typically, the active detergent is delivered with a process oil. The “as delivered” detergent typically contains from about 20 weight percent to about 100 weight percent, or from about 40 weight percent to about 60 weight percent, of active detergent in the “as delivered” detergent product.

### Dispersants

The lubricating oil compositions include at least one dispersant. During engine operation, oil-insoluble oxidation byproducts are produced. Dispersants help keep these byproducts in solution, thus diminishing their deposition on metal surfaces. Dispersants used in the formulating of the lubricating oil may be ashless or ash-forming in nature. Preferably, the dispersant is ashless. So called ashless dispersants are organic materials that form substantially no ash upon combustion. For example, non-metal-containing or borated metal-free dispersants are considered ashless.

Suitable dispersants typically contain a polar group attached to a relatively high molecular weight hydrocarbon chain. The polar group typically contains at least one element of nitrogen, oxygen, or phosphorus. Typical hydrocarbon chains contain 50 to 400 carbon atoms.

A particularly useful class of dispersants are the (poly)alkenylsuccinic derivatives, typically produced by the reaction of a long chain hydrocarbyl substituted succinic compound, usually a hydrocarbyl substituted succinic anhydride, with a polyhydroxy or polyamino compound. The long chain hydrocarbyl group constituting the oleophilic portion of the molecule which confers solubility in the oil, is normally a polyisobutylene group. Many examples of this type of dispersant are well known commercially and in the literature. Exemplary U.S. patents describing such dispersants are U.S. Pat. Nos. 3,172,892; 3,2145,707; 3,219,666; 3,316,177; 3,341,542; 3,444,170; 3,454,607; 3,541,012; 3,630,904; 3,632,511; 3,787,374 and 4,234,435. Other types of dispersant are described in U.S. Pat. Nos. 3,036,003; 3,200,107; 3,254,025; 3,275,554; 3,438,757; 3,454,555; 3,565,804; 3,413,347; 3,697,574; 3,725,277; 3,725,480; 3,726,882; 4,454,059; 3,329,658; 3,449,250; 3,519,565; 3,666,730; 3,687,849; 3,702,300; 4,100,082; 5,705,458. A further description of dispersants may be found, for example, in European Patent Application No. 471 071, to which reference is made for this purpose.

Hydrocarbyl-substituted succinic acid and hydrocarbyl-substituted succinic anhydride derivatives are useful dispersants. In particular, succinimide, succinate esters, or succinate ester amides prepared by the reaction of a hydrocarbon-substituted succinic acid compound preferably having at least 50 carbon atoms in the hydrocarbon substituent, with at least one equivalent of an alkylene amine are particularly useful.

Succinimides are formed by the condensation reaction between hydrocarbyl substituted succinic anhydrides and amines. Molar ratios can vary depending on the polyamine. For example, the molar ratio of hydrocarbyl substituted succinic anhydride to TEPA can vary from about 1:1 to about 5:1. Representative examples are shown in U.S. Pat. Nos. 3,087,936; 3,172,892; 3,219,666; 3,272,746; 3,322,670; and U.S. Pat. Nos. 3,652,616, 3,948,800.

Succinate esters are formed by the condensation reaction between hydrocarbyl substituted succinic anhydrides and alcohols or polyols. Molar ratios can vary depending on the alcohol or polyol used. For example, the condensation product of a hydrocarbyl substituted succinic anhydride and pentaerythritol is a useful dispersant.

Succinate ester amides are formed by condensation reaction between hydrocarbyl substituted succinic anhydrides and alkanol amines. For example, suitable alkanol amines include ethoxylated polyalkylpolyamines, propoxylated polyalkylpolyamines and polyalkenylpolyamines such as polyethylene polyamines. One example is propoxylated hexamethylenediamine. Representative examples are shown in U.S. Pat. No. 4,426,305.

The molecular weight of the hydrocarbyl substituted succinic anhydrides used in the preceding paragraphs will typically range between 800 and 2,500 or more. The above products can be post-reacted with various reagents such as sulfur, oxygen, formaldehyde, carboxylic acids such as oleic acid. The above products can also be post reacted with boron compounds such as boric acid, borate esters or highly borated dispersants, to form borated dispersants generally having from about 0.1 to about 5 moles of boron per mole of dispersant reaction product. Further, metal modified versions of the above succinic derived dispersants are known, with illustrative examples that include zinc-modified alkyl succinimide types.

Mannich base dispersants are made from the reaction of alkylphenols, formaldehyde, and amines. See U.S. Pat. No. 4,767,551, which is incorporated herein by reference. Process aids and catalysts, such as oleic acid and sulfonic acids, can also be part of the reaction mixture. Molecular weights of the alkylphenols range from 800 to 2,500. Representative examples are shown in U.S. Pat. Nos. 3,697,574; 3,703,536; 3,704,308; 3,751,365; 3,756,953; 3,798,165; and 3,803,039.

Typical high molecular weight aliphatic acid modified Mannich condensation products useful in this disclosure can be prepared from high molecular weight alkyl-substituted hydroxyaromatics or HNR₂ group-containing reactants.

Hydrocarbyl substituted amine ashless dispersant additives are well known to one skilled in the art; see, for example, U.S. Pat. Nos. 3,275,554; 3,438,757; 3,565,804; 3,755,433, 3,822,209, and 5,084,197.

Illustrative dispersants include borated and non-borated succinimides, including those derivatives from mono-succinimides, bis-succinimides, and/or mixtures of mono- and bis-succinimides, wherein the hydrocarbyl succinimide is derived from a hydrocarbylene group such as polyisobutylene having a Mn of from about 500 to about 5000, or from about 1000 to about 3000, or about 1000 to about 2000, or a mixture of such hydrocarbylene groups, often with high terminal vinylic groups. Other preferred dispersants include succinic acid-esters and amides, alkylphenol-polyamine-coupled Mannich adducts, their capped derivatives, and other related components.

Polymethacrylate or polyacrylate derivatives are another class of dispersants. These dispersants are typically prepared by reacting a nitrogen containing monomer and a methacrylic or acrylic acid esters containing 5-25 carbon atoms in the ester group. Representative examples are shown in U.S. Pat. Nos. 2,100,993, and 6,323,164. Polymethacrylate and polyacrylate dispersants are normally used as multifunctional viscosity modifiers. The lower molecular weight versions can be used as lubricant dispersants or fuel detergents.

Other illustrative dispersants useful in this disclosure include those derived from polyalkenyl-substituted mono- or dicarboxylic acid, anhydride or ester, which dispersant has a polyalkenyl moiety with a number average molecular weight of at least 900 and from greater than 1.3 to 1.7, preferably from greater than 1.3 to 1.6, most preferably from greater than 1.3 to 1.5, functional groups (mono- or dicarboxylic acid producing moieties) per polyalkenyl moiety (a medium functionality dispersant). Functionality (F) can be determined according to the following formula:

F=(SAP×Mₙ)/((112,200×A.I.)−(SAP×98))

wherein SAP is the saponification number (i.e., the number of milligrams of KOH consumed in the complete neutralization of the acid groups in one gram of the succinic-containing reaction product, as determined according to ASTM D94); Mₙ is the number average molecular weight of the starting olefin polymer; and A.I. is the percent active ingredient of the succinic-containing reaction product (the remainder being unreacted olefin polymer, succinic anhydride and diluent).

The polyalkenyl moiety of the dispersant may have a number average molecular weight of at least 900, suitably at least 1500, preferably between 1800 and 3000, such as between 2000 and 2800, more preferably from about 2100 to 2500, and most preferably from about 2200 to about 2400. The molecular weight of a dispersant is generally expressed in terms of the molecular weight of the polyalkenyl moiety. This is because the precise molecular weight range of the dispersant depends on numerous parameters including the type of polymer used to derive the dispersant, the number of functional groups, and the type of nucleophilic group employed.

Polymer molecular weight, specifically Mₙ, can be determined by various known techniques. One convenient method is gel permeation chromatography (GPC), which additionally provides molecular weight distribution information (see W. W. Yau, J. J. Kirkland and D. D. Bly, “Modern Size Exclusion Liquid Chromatography”, John Wiley and Sons, New York, 1979). Another useful method for determining molecular weight, particularly for lower molecular weight polymers, is vapor pressure osmometry (e.g., ASTM D3592).

The polyalkenyl moiety in a dispersant preferably has a narrow molecular weight distribution (MWD), also referred to as polydispersity, as determined by the ratio of weight average molecular weight (M_{w}) to number average molecular weight (Mₙ). Polymers having a M_{w}/Mₙ of less than 2.2, preferably less than 2.0, are most desirable. Suitable polymers have a polydispersity of from about 1.5 to 2.1, preferably from about 1.6 to about 1.8.

Suitable polyalkenes employed in the formation of the dispersants include homopolymers, interpolymers or lower molecular weight hydrocarbons. One family of such polymers comprise polymers of ethylene and/or at least one C₃ to C₂₄ alpha-olefin. Preferably, such polymers comprise interpolymers of ethylene and at least one alpha-olefin of the above formula.

Another useful class of polymers is polymers prepared by cationic polymerization of monomers such as isobutene and styrene. Common polymers from this class include polyisobutenes obtained by polymerization of a C₄ refinery stream having a butene content of 35 to 75% by wt., and an isobutene content of 30 to 60% by wt. A preferred source of monomer for making poly-n-butenes is petroleum feedstreams such as Raffinate II. These feedstocks are disclosed in the art such as in U.S. Pat. No. 4,952,739. A preferred embodiment utilizes polyisobutylene prepared from a pure isobutylene stream or a Raffinate I stream to prepare reactive isobutylene polymers with terminal vinylidene olefins. Polyisobutene polymers that may be employed are generally based on a polymer chain of from 1500 to 3000.

Dispersants that contain the alkenyl or alkyl group have an Mₙ value of about 500 to about 5000 and an M_{w}/Mₙ ratio of about 1 to about 5. The preferred Mₙ intervals depend on the chemical nature of the agent improving filterability. Polyolefinic polymers suitable for the reaction with maleic anhydride or other acid materials or acid forming materials, include polymers containing a predominant quantity of C₂ to C₅ monoolefins, for example, ethylene, propylene, butylene, isobutylene and pentene. A highly suitable polyolefinic polymer is polyisobutene. The succinic anhydride preferred as a reaction substance is PIBSA, that is, polyisobutenyl succinic anhydride.

If the dispersant contains a succinimide comprising the reaction product of a succinic anhydride with a polyamine, the alkenyl or alkyl substituent of the succinic anhydride serving as the reaction substance consists preferably of polymerised isobutene having an Mₙ value of about 1200 to about 2500. More advantageously, the alkenyl or alkyl substituent of the succinic anhydride serving as the reaction substance consists in a polymerised isobutene having an Mₙ value of about 2100 to about 2400. If the agent improving filterability contains an ester of succinic acid comprising the reaction product of a succinic anhydride and an aliphatic polyhydric alcohol, the alkenyl or alkyl substituent of the succinic anhydride serving as the reaction substance consists advantageously of a polymerised isobutene having an Mₙ value of 500 to 1500. In preference, a polymerised isobutene having an Mₙ value of 850 to 1200 is used.

The amides may be amides of mono- or polycarboxylic acids or reactive derivatives thereof. The amides may be characterized by a hydrocarbyl group containing from about 6 to about 90 carbon atoms; each is independently hydrogen or a hydrocarbyl, aminohydrocarbyl, hydroxyhydrocarbyl or a heterocyclic-substituted hydrocarbyl group, provided that both are not hydrogen; each is, independently, a hydrocarbylene group containing up to about 10 carbon atoms.

The amide can be derived from a monocarboxylic acid, a hydrocarbyl group containing from 6 to about 30 or 38 carbon atoms and more often will be a hydrocarbyl group derived from a fatty acid containing from 12 to about 24 carbon atoms.

An illustrative amide that is derived from a di- or tricarboxylic acid, will contain from 6 to about 90 or more carbon atoms depending on the type of polycarboxylic acid. For example, when the amide is derived from a dimer acid, will contain from about 18 to about 44 carbon atoms or more, and amides derived from trimer acids generally will contain an average of from about 44 to about 90 carbon atoms. Each is independently hydrogen or a hydrocarbyl, aminohydrocarbyl, hydroxyhydrocarbyl or a heterocyclic-substituted hydrocarbon group containing up to about 10 carbon atoms. It may be independently heterocyclic substituted hydrocarbyl groups wherein the heterocyclic substituent is derived from pyrrole, pyrroline, pyrrolidine, morpholine, piperazine, piperidine, pyridine, pipecoline, etc. Specific examples include methyl, ethyl, n-propyl, n-butyl, n-hexyl, hydroxymethyl, hydroxyethyl, hydroxypropyl, amino-methyl, aminoethyl, aminopropyl, 2-ethylpyridine, 1-ethylpyrrolidine, 1-ethylpiperidine, etc.

Illustrative aliphatic monoamines include mono-aliphatic and di-aliphatic-substituted amines wherein the aliphatic groups may be saturated or unsaturated and straight chain or branched chain. Such amines include, for example, mono- and di-alkyl-substituted amines, mono- and dialkenyl-substituted amines, etc. Specific examples of such monoamines include ethyl amine, diethyl amine, n-butyl amine, di-n-butyl amine, isobutyl amine, coco amine, stearyl amine, oleyl amine, etc. An example of a cycloaliphatic-substituted aliphatic amine is 2-(cyclohexyl)-ethyl amine. Examples of heterocyclic-substituted aliphatic amines include 2-(2-aminoethyl)-pyrrole, 2-(2-aminoethyl)-1-methylpyrrole, 2-(2-aminoethyl)-1-methylpyrrolidine and 4-(2-aminoethyl)morpholine, 1-(2-aminoethyl)piperazine, 1-(2-aminoethyl)piperidine, 2-(2-aminoethyl)pyridine, 1-(2-aminoethyl)pyrrolidine, 1-(3-aminopropyl)imidazole, 3-(2-aminopropyl)indole, 4-(3-aminopropyl)morpholine, 1-(3-aminopropyl)-2-pipecoline, 1-(3-aminopropyl)-2-pyrrolidinone, etc.

Illustrative cycloaliphatic monoamines are those monoamines wherein there is one cycloaliphatic substituent attached directly to the amino nitrogen through a carbon atom in the cyclic ring structure. Examples of cycloaliphatic monoamines include cyclohexylamines, cyclopentylamines, cyclohexenylamines, cyclopentenylamines, N-ethyl-cyclohexylamine, dicyclohexylamines, and the like. Examples of aliphatic-substituted, aromatic-substituted, and heterocyclic-substituted cycloaliphatic monoamines include propyl-substituted cyclohexylamines, phenyl-substituted cyclopentylamines, and pyranyl-substituted cyclohexylamine.

Illustrative aromatic amines include those monoamines wherein a carbon atom of the aromatic ring structure is attached directly to the amino nitrogen. The aromatic ring will usually be a mononuclear aromatic ring (i.e., one derived from benzene) but can include fused aromatic rings, especially those derived from naphthalene. Examples of aromatic monoamines include aniline, di-(para-methylphenyl)amine, naphthylamine, N-(n-butyl)-aniline, and the like. Examples of aliphatic-substituted, cycloaliphatic-substituted, and heterocyclic-substituted aromatic monoamines are para-ethoxy-aniline, para-dodecylaniline, cyclohexyl-substituted naphthylamine, variously substituted phenathiazines, and thienyl-substituted aniline.

Illustrative polyamines are aliphatic, cycloaliphatic and aromatic polyamines analogous to the above-described monoamines except for the presence within their structure of additional amino nitrogens. The additional amino nitrogens can be primary, secondary or tertiary amino nitrogens. Examples of such polyamines include N-amino-propyl-cyclohexylamines, N,N′-di-n-butyl-paraphenylene diamine, bis-(para-aminophenyl)methane, 1,4-diaminocyclohexane, and the like.

Illustrative hydroxy-substituted amines are those having hydroxy substituents bonded directly to a carbon atom other than a carbonyl carbon atom; that is, they have hydroxy groups capable of functioning as alcohols. Examples of such hydroxy-substituted amines include ethanolamine, di-(3-hydroxypropyl)-amine, 3-hydroxy butyl-amine, 4-hydroxy butyl-amine, diethanolamine, di-(2-hydroxy amine, N-(hydroxypropyl)-propylamine, N-(2-methyl)-cyclohexylamine, 3-hydroxycyclopentyl parahydroxy aniline, N-hydroxyethal piperazine and the like.

In one embodiment, the amines are alkylene polyamines including hydrogen, or a hydrocarbyl, amino hydrocarbyl, hydroxyhydrocarbyl or heterocyclic-substituted hydrocarbyl group containing up to about 10 carbon atoms. Examples of such alkylene polyamines include methylene polyamines, ethylene polyamines, butylene polyamines, propylene polyamines, pentylene polyamines, hexylene polyamines, heptylene polyamines, etc.

Alkylene polyamines include ethylene diamine, triethylene tetramine, propylene diamine, trimethylene diamine, hexamethylene diamine, decamethylene diamine, hexamethylene diamine, decamethylene diamine, octamethylene diamine, di(heptamethylene) triamine, tripropylene tetramine, tetraethylene pentamine, trimethylene diamine, pentaethylene hexamine, di(trimethylene)triamine, and the like. Higher homologs as are obtained by condensing two or more of the above-illustrated alkylene amines are useful, as are mixtures of two or more of any of the afore-described polyamines.

Ethylene polyamines, such as those mentioned above, are especially useful for reasons of cost and effectiveness. Such polyamines are described in detail under the heading “Diamines and Higher Amines” in The Encyclopedia of Chemical Technology, Second Edition, Kirk and Othmer, Volume 7, pages 27-39, Interscience Publishers, Division of John Wiley and Sons, 1965, which is hereby incorporated by reference for the disclosure of useful polyamines. Such compounds are prepared most conveniently by the reaction of an alkylene chloride with ammonia or by reaction of an ethylene imine with a ring-opening reagent such as ammonia, etc. These reactions result in the production of the somewhat complex mixtures of alkylene polyamines, including cyclic condensation products such as piperazines.

Other useful types of polyamine mixtures are those resulting from stripping of the above-described polyamine mixtures. In this instance, lower molecular weight polyamines and volatile contaminants are removed from an alkylene polyamine mixture to leave as residue what is often termed “polyamine bottoms”. In general, alkylene polyamine bottoms can be characterized as having less than 2, usually less than 1% (by weight) material boiling below about 200° C. In the instance of ethylene polyamine bottoms, which are readily available and found to be quite useful, the bottoms contain less than about 2% (by weight) total diethylene triamine (DETA) or triethylene tetramine (TETA). A typical sample of such ethylene polyamine bottoms obtained from the Dow Chemical Company of Freeport, Tex. designated “E-100”. Gas chromatography analysis of such a sample showed it to contain about 0.93% “Light Ends” (most probably DETA), 0.72% TETA, 21.74% tetraethylene pentamine and 76.61% pentaethylene hexamine and higher (by weight). These alkylene polyamine bottoms include cyclic condensation products such as piperazine and higher analogs of diethylene triamine, triethylene tetramine and the like.

Illustrative dispersants are selected from: Mannich bases that are condensation reaction products of a high molecular weight phenol, an alkylene polyamine and an aldehyde such as formaldehyde; succinic-based dispersants that are reaction products of a olefin polymer and succinic acylating agent (acid, anhydride, ester or halide) further reacted with an organic hydroxy compound and/or an amine; high molecular weight amides and esters such as reaction products of a hydrocarbyl acylating agent and a polyhydric aliphatic alcohol (such as glycerol, pentaerythritol or sorbitol). Ashless (metal-free) polymeric materials that usually contain an oil soluble high molecular weight backbone linked to a polar functional group that associates with particles to be dispersed are typically used as dispersants. Zinc acetate capped, also any treated dispersant, which include borated, cyclic carbonate, end-capped, polyalkylene maleic anhydride and the like; mixtures of some of the above, in treat rates that range from about 0.1% up to 10-20% or more. Commonly used hydrocarbon backbone materials are olefin polymers and copolymers, i.e., ethylene, propylene, butylene, isobutylene, styrene; there may or may not be further functional groups incorporated into the backbone of the polymer, whose molecular weight ranges from 300 tp to 5000. Polar materials such as amines, alcohols, amides or esters are attached to the backbone via a bridge.

The dispersant(s) are preferably non-polymeric (e.g., mono- or bis-succinimides). Such dispersants can be prepared by conventional processes such as disclosed in U.S. Patent Application Publication No. 2008/0020950, the disclosure of which is incorporated herein by reference.

The dispersant(s) can be borated by conventional means, as generally disclosed in U.S. Pat. Nos. 3,087,936, 3,254,025 and 5,430,105.

Such dispersants may be used in an amount of about 0.01 to 20 weight percent or 0.01 to 10 weight percent, preferably about 0.5 to 8 weight percent, or more preferably 0.5 to 4 weight percent. Or such dispersants may be used in an amount of about 2 to 12 weight percent, preferably about 4 to 10 weight percent, or more preferably 6 to 9 weight percent. On an active ingredient basis, such additives may be used in an amount of about 0.06 to 14 weight percent, preferably about 0.3 to 6 weight percent. The hydrocarbon portion of the dispersant atoms can range from C₆₀ to C₁₀₀₀, or from C₇₀ to C₃₀₀, or from C₇₀ to C₂₀₀. These dispersants may contain both neutral and basic nitrogen, and mixtures of both. Dispersants can be end-capped by borates and/or cyclic carbonates. Nitrogen content in the finished oil can vary from about 200 ppm by weight to about 2000 ppm by weight, preferably from about 200 ppm by weight to about 1200 ppm by weight. Basic nitrogen can vary from about 100 ppm by weight to about 1000 ppm by weight, preferably from about 100 ppm by weight to about 600 ppm by weight.

As used herein, the dispersant concentrations are given on an “as delivered” basis. Typically, the active dispersant is delivered with a process oil. The “as delivered” dispersant typically contains from about 20 weight percent to about 80 weight percent, or from about 40 weight percent to about 60 weight percent, of active dispersant in the “as delivered” dispersant product.

### Antiwear Additives

The lubricating oil compositions include at least one antiwear agent. Examples of suitable antiwear agents include oil soluble amine salts of phosphorus compounds, sulfurized olefins, metal dihydrocarbyldithio-phosphates (such as zinc dialkyldithiophosphates), thiocarbamate-containing compounds, such as thiocarbamate esters, thiocarbamate amides, thiocarbamic ethers, alkylene-coupled thiocarbamates, and bis(S-alkyldithiocarbamyl) disulfides.

Antiwear agents used in the formulating of the lubricating oil may be ashless or ash-forming in nature. Preferably, the antiwear agent is ashless. So called ashless antiwear agents are materials that form substantially no ash upon combustion. For example, non-metal-containing antiwear agents are considered ashless.

In one embodiment, oil soluble phosphorus amine antiwear agents include an amine salt of a phosphorus acid ester or mixtures thereof. The amine salt of a phosphorus acid ester includes phosphoric acid esters and amine sails thereof; dialkyldithiophosphoric acid esters and amine salts thereof, amine salts of phosphites; and amine salts of phosphorus-containing carboxylic esters, ethers, and amides; and mixtures thereof. The amine salt of a phosphorus acid ester may be used alone or in combination.

In one embodiment, oil soluble phosphorus amine salts include partial amine salt-partial metal salt compounds or mixtures thereof. In one embodiment, the phosphorus compound further includes a sulfur atom in the molecule. In one embodiment, the amine salt of the phosphorus compound may be ashless, i.e., metal-free (prior to being mixed with other components).

The amines which may be suitable for use as the amine salt include primary amines, secondary amines, tertiary amines, and mixtures thereof. The amines include those with at least one hydrocarbyl group, or, in certain embodiments, two or three hydrocarbyl groups. The hydrocarbyl groups may contain 2 to 30 carbon atoms, or in other embodiments 8 to 26, or 10 to 20, or 13 to 19 carbon atoms.

Primary amines include ethylamine, propylamine, butylamine, 2-ethylhexylamine, octylamine, and dodecylamine, as well as such fatty amines as n-octylamine, n-decylamine, n-dodeclyamine, n-tetradecylamine, n-hexadecylamine, n-octadecylamine and oleyamine. Other useful fatty amines include commercially available fatty amines such as “Armeen™” amines (products available from Akzo Chemicals, Chicago, Ill.), such as Armeen C, Armeen O, Armeen OL, Armeen T, Armeen HT, Armeen S and Armeen SD, wherein the letter designation relates to the fatty group, such as coco, oleyl, tallow, or stearyl groups.

Examples of suitable secondary amines include dim ethylamine, diethylamine, dipropylamine, dibutylamine, diamylamine, dihexylamine, diheptylamine, methylethylamine, ethylbutylamine and ethylamylamine. The secondary amines may be cyclic amines such as piperidine, piperazine and morpholine.

The amine may also be a tertiary-aliphatic primary amine. The aliphatic group in this case may be an alkyl group containing 2 to 30, or 6 to 26, or 8 to 24 carbon atoms. Tertiary alkyl amines include monoamines such as tert-butylamine, tert-hexylamine, 1-methyl-1-amino-cyclohexane, tert-octylamine, tert-decylamine, tertdodecylamine, tert-tetradecylamine, tert-hexadecylamine, tert-octadecylamine, tert-tetracosanylamine, and tert-octacosanylamine.

In one embodiment, the phosphorus acid amine salt includes an amine with C₁₁ to C₁₄ tertiary alkyl primary groups or mixtures thereof. In one embodiment the phosphorus acid amine salt includes an amine with C₁₄ to C₁₈ tertiary alkyl primary amines or mixtures thereof. In one embodiment the phosphorus acid amine salt includes an amine with Cis to C₂₂ tertiary alkyl primary amines or mixtures thereof.

Mixtures of amines may also be used in the disclosure. In one embodiment a useful mixture of amines is “Primene™ 81R” and “Primene™ JMT.” Primene™ 81R and Primene™ JMT (both produced and sold by Rohm & Haas) are mixtures of C₁₁ to C₁₄ tertiary alkyl primary amines and C₁₈ to C₂₂ tertiary alkyl primary amines respectively.

In one embodiment, oil soluble amine salts of phosphorus compounds include a sulfur-free amine salt of a phosphorus-containing compound may be obtained/obtainable by a process comprising: reacting an amine with either (i) a hydroxy-substituted di-ester of phosphoric acid, or (ii) a phosphorylated hydroxy-substituted di- or tri-ester of phosphoric acid. A more detailed description of compounds of this type is disclosed in International Application PCT/US08/051126.

In one embodiment, the hydrocarbyl amine salt of an alkylphosphoric acid ester is the reaction product of a C₁₄ to C₁₈ alkylated phosphoric acid with Primene 81RT™ (produced and sold by Rohm & Haas) which is a mixture of C₁₁ to C₁₄ tertiary alkyl primary amines.

Examples of hydrocarbyl amine salts of dialkyldithiophosphoric acid esters include the reaction product(s) of isopropyl, methyl-amyl (4-methyl-2-pentyl or mixtures thereof), 2-ethylhexyl, heptyl, octyl or nonyl dithiophosphoric acids with ethylene diamine, morpholine, or Primene 81R™, and mixtures thereof.

In one embodiment, the dithiophosphoric acid may be reacted with an epoxide or a glycol. This reaction product is further reacted with a phosphorus acid, anhydride, or lower ester. The epoxide includes an aliphatic epoxide or a styrene oxide. Examples of useful epoxides include ethylene oxide, propylene oxide, butene oxide, octene oxide, dodecene oxide, and styrene oxide. In one embodiment, the epoxide may be propylene oxide. The glycols may be aliphatic glycols having from 1 to 12, or from 2 to 6, or 2 to 3 carbon atoms. The dithiophosphoric acids, glycols, epoxides, inorganic phosphorus reagents and methods of reacting the same are described in U.S. Pat. Nos. 3,197,405 and 3,544,465. The resulting acids may then be salted with amines.

The dithiocarbamate-containing compounds may be prepared by reacting a dithiocarbamate acid or salt with an unsaturated compound. The dithiocarbamate containing compounds may also be prepared by simultaneously reacting an amine, carbon disulfide and an unsaturated compound. Generally, the reaction occurs at a temperature from 25° C. to 125° C.

Examples of suitable olefins that may be sulfurized to form the sulfurized olefin include propylene, butylene, isobutylene, pentene, hexane, heptene, octane, nonene, decene, undecene, dodecene, undecyl, tridecene, tetradecene, pentadecene, hexadecene, heptadecene, octadecene, octadecenene, nonodecene, eicosene or mixtures thereof. In one embodiment, hexadecene, heptadecene, octadecene, octadecenene, nonodecene, eicosene or mixtures thereof and their dimers, trimers and tetramers are especially useful olefins. Alternatively, the olefin may be a Diels-Alder adduct of a diene such as 1,3-butadiene and an unsaturated ester, such as, butylacrylate.

Another class of sulfurized olefin includes fatty acids and their esters. The fatty acids are often obtained from vegetable oil or animal oil; and typically contain 4 to 22 carbon atoms. Examples of suitable fatty acids and their esters include triglycerides, oleic acid, linoleic acid, palmitoleic acid or mixtures thereof. Often, the fatty acids are obtained from lard oil, tall oil, peanut oil, soybean oil, cottonseed oil, sunflower seed oil or mixtures thereof. In one embodiment fatty acids and/or ester are mixed with olefins.

Polyols include diols, triols, and alcohols with higher numbers of alcoholic OH groups. Polyhydric alcohols include ethylene glycols, including di-, tri- and tetraethylene glycols; propylene glycols, including di-, tri- and tetrapropylene glycols; glycerol; butane diol; hexane diol; sorbitol; arabitol; mannitol; sucrose; fructose; glucose; cyclohexane diol; erythritol; and penta-erythritols, including di- and tripentaerythritol. Often the polyol is diethylene glycol, triethylene glycol, glycerol, sorbitol, penta erythritol or dipentaerythritol.

In an alternative embodiment, the ashless antiwear agent may be a monoester of a polyol and an aliphatic carboxylic acid, often an acid containing 12 to 24 carbon atoms. Often the monoester of a polyol and an aliphatic carboxylic acid is in the form of a mixture with a sunflower oil or the like, which may be present in the mixture from 5 to 95, in several embodiments from 10 to 90, or from 20 to 85, or 20 to 80 weight percent of said mixture. The aliphatic carboxylic acids (especially a monocarboxylic acid) which form the esters are those acids typically containing 12 to 24, or from 14 to 20 carbon atoms. Examples of carboxylic acids include dodecanoic acid, stearic acid, lauric acid, behenic acid, and oleic acid.

Illustrative antiwear additives useful in this disclosure include, for example, metal salts of a carboxylic acid. The metal is selected from a transition metal and mixtures thereof. The carboxylic acid is selected from an aliphatic carboxylic acid, a cycloaliphatic carboxylic acid, an aromatic carboxylic acid, and mixtures thereof.

The metal is preferably selected from a Group 10, 11 and 12 metal, and mixtures thereof. The carboxylic acid is preferably an aliphatic, saturated, unbranched carboxylic acid having from about 8 to about 26 carbon atoms, and mixtures thereof.

The metal is preferably selected from nickel (Ni), palladium (Pd), platinum (Pt), copper (Cu), silver (Ag), gold (Au), zinc (Zn), and mixtures thereof.

The carboxylic acid is preferably selected from caprylic acid (C8), pelargonic acid (C9), capric acid (C10), undecylic acid (C11), lauric acid (C12), tridecylic acid (C13), myristic acid (C14), pentadecylic acid (C15), palmitic acid (C16), margaric acid (C17), stearic acid (C18), nonadecylic acid (C19), arachidic acid (C20), heneicosylic acid (C21), behenic acid (C22), tricosylic acid (C23), lignoceric acid (C24), pentacosylic acid (C25), cerotic acid (C26), and mixtures thereof.

Preferably, the metal salt of a carboxylic acid comprises zinc stearate, silver stearate, palladium stearate, zinc palmitate, silver palmitate, palladium palmitate, and mixtures thereof.

The metal salt of a carboxylic acid is present in the engine oil compositions of this disclosure in an amount of from about 0.01 weight percent to about 5 weight percent, based on the total weight of the lubricating oil composition.

A metal alkylthiophosphate and more particularly a metal dialkyl dithio phosphate in which the metal constituent is zinc, or zinc dialkyl dithio phosphate (ZDDP) can be a useful component of the lubricating oils of this disclosure. ZDDP can be derived from primary alcohols, secondary alcohols or mixtures thereof. ZDDP compounds generally are of the formula

Zn[SP(S)(OR¹)(OR²)]₂

where R¹ and R² are C₁-C₁₈ alkyl groups, preferably C₂-C₁₂ alkyl groups. These alkyl groups may be straight chain or branched. Alcohols used in the ZDDP can be 2-propanol, butanol, secondary butanol, pentanols, hexanols such as 4-methyl-2-pentanol, n-hexanol, n-octanol, 2-ethyl hexanol, alkylated phenols, and the like. Mixtures of secondary alcohols or of primary and secondary alcohol can be preferred. Alkyl aryl groups may also be used.

Preferable zinc dithiophosphates which are commercially available include secondary zinc dithiophosphates such as those available from for example, The Lubrizol Corporation under the trade designations “LZ 677A”, “LZ 1095” and “LZ 1371”, from for example Chevron Oronite under the trade designation “OLOA 262” and from for example Afton Chemical under the trade designation “HITEC 7169”.

The ZDDP is typically used in amounts of from about 0.4 weight percent to about 1.2 weight percent, preferably from about 0.5 weight percent to about 1.0 weight percent, and more preferably from about 0.6 weight percent to about 0.8 weight percent, based on the total weight of the lubricating oil, although more or less can often be used advantageously. Preferably, the ZDDP is a secondary ZDDP and present in an amount of from about 0.6 to 1.0 weight percent of the total weight of the lubricating oil.

Low phosphorus engine oil compositions are included in this disclosure. For such compositions, the phosphorus content is typically less than about 0.12 weight percent, preferably less than about 0.10 weight percent, and most preferably less than about 0.085 weight percent, and in certain instances less than about 0.065 weight percent.

Other illustrative antiwear agents useful in this disclosure include, for example, zinc alkyldithiophosphates, aryl phosphates and phosphites, sulfur-containing esters, phosphosulfur compounds, and metal or ash-free dithiocarbamates.

The antiwear additive concentration in the lubricating oils of this disclosure can range from about 0.01 to about 5 weight percent, preferably about 0.1 to 4.5 weight percent, and more preferably from about 0.2 weight percent to about 4 weight percent, based on the total weight of the lubricating oil.

### Corrosion Inhibitors

The lubricating oil compositions include at least one corrosion inhibitor. Corrosion inhibitors are used to reduce the degradation of metallic parts that are in contact with the lubricating oil composition. Suitable corrosion inhibitors include aryl thiazines, alkyl substituted dimercaptothiodiazoles, alkyl substituted dimercaptothiadiazoles, and mixtures thereof.

Corrosion inhibitors are additives that protect lubricated metal surfaces against chemical attack by water or other contaminants. A wide variety of these are commercially available. As used herein, corrosion inhibitors include antirust additives and metal deactivators.

One type of corrosion inhibitor is a polar compound that wets the metal surface preferentially, protecting it with a film of oil. Another type of corrosion inhibitor absorbs water by incorporating it in a water-in-oil emulsion so that only the oil touches the metal surface. Yet another type of corrosion inhibitor chemically adheres to the metal to produce a non-reactive surface. Examples of suitable additives include zinc dithiophosphates, metal phenolates, basic metal sulfonates, fatty acids and amines. Such additives may be used in an amount of about 0.01 to 5 weight percent, preferably about 0.01 to 1.5 weight percent.

Illustrative corrosion inhibitors include (short-chain) alkenyl succinic acids, partial esters thereof and nitrogen-containing derivatives thereof; and synthetic alkarylsulfonates, such as metal dinonylnaphthalene sulfonates. Corrosion inhbiitors include, for example, monocarboxylic acids which have from 8 to 30 carbon atoms, alkyl or alkenyl succinates or partial esters thereof, hydroxy-fatty acids which have from 12 to 30 carbon atoms and derivatives thereof, sarcosines which have from 8 to 24 carbon atoms and derivatives thereof, amino acids and derivatives thereof, naphthenic acid and derivatives thereof, lanolin fatty acid, mercapto-fatty acids and paraffin oxides.

Particularly preferred corrosion inhibitors are indicated below. Examples of monocarboxylic acids (C₈-C₃₀), Caprylic acid, pelargonic acid, decanoic acid, undecanoic acid, lauric acid, myristic acid, palmitic acid, stearic acid, arachic acid, behenic acid, cerotic acid, montanic acid, melissic acid, oleic acid, docosanic acid, erucic acid, eicosenic acid, beef tallow fatty acid, soy bean fatty acid, coconut oil fatty acid, linolic acid, linoleic acid, tall oil fatty acid, 12-hydroxystearic acid, laurylsarcosinic acid, myritsylsarcosinic acid, palmitylsarcosinic acid, stearylsarcosinic acid, oleylsarcosinic acid, alkylated (C₈-C₂₀) phenoxyacetic acids, lanolin fatty acid and C₈-C₂₄ mercapto-fatty acids.

Examples of polybasic carboxylic acids which function as corrosion inhibitors include alkenyl (C₁₀-C₁₀₀) succinic acids and ester derivatives thereof, dimer acid, N-acyl-N-alkyloxyalkyl aspartic acid esters (U.S. Pat. No. 5,275,749). Examples of the alkylamines which function as corrosion inhibitors or as reaction products with the above carboxylates to give amides and the like are represented by primary amines such as laurylamine, coconut-amine, n-tridecylamine, myristylamine, n-pentadecylamine, palmitylamine, n-heptadecylamine, stearylamine, n-nonadecylamine, n-eicosylamine, n-heneicosylamine, n-docosylamine, n-tricosylamine, n-pentacosylamine, oleylamine, beef tallow-amine, hydrogenated beef tallow-amine and soy bean-amine. Examples of the secondary amines include dilaurylamine, di-coconut-amine, di-n-tri decyl amine, dimyristylamine, di-n-pentadecylamine, dipalmitylamine, di-n-pentadecylamine, distearylamine, di-n-nonadecylamine, di-n-eicosylamine, di-n-heneicosylamine, di-n-docosylamine, di-n-tricosylamine, di-n-pentacosyl-amine, dioleylamine, di-beef tallow-amine, di-hydrogenated beef tallow-amine and di-soy bean-amine. Examples of the aforementioned N-alkylpolyalkyenediamines include: ethylenediamines such as laurylethylenediamine, coconut ethylenediamine, n-tridecylethylenediamine-, myristylethylenediamine, n-pentadecylethylenedi amine, palmitylethylenediamine, n-heptadecylethylenediamine, stearylethylenediamine, n-nonadecylethylenediamine, n-eicosylethylenediamine, n-heneicosylethylenediamine, n-docosylethylendiamine, n-tricosylethylenediamine, n-pentacosylethylenediamine, oleylethylenediamine, beef tallow-ethylenediamine, hydrogenated beef tallow-ethylenediamine and soy bean-ethylenediamine; propylenediamines such as laurylpropylenediamine, coconut propylenediamine, n-tridecylpropylenediamine, myristylpropylenediamine, n-pentadecylpropylenediamine, palmitylpropylenediamine, n-heptadecylpropylenediamine, stearylpropylenediamine, n-nonadecylpropylenediamine, n-eicosylpropylenediamine, n-heneicosylpropylenediamine, n-docosylpropylendiamine, n-tricosylpropylenediamine, n-pentacosylpropylenediamine, diethylene triamine (DETA) or triethylene tetramine (TETA), oleylpropylenediamine, beef tallow-propylenediamine, hydrogenated beef tallow-propylenediamine and soy bean-propylenediamine; butylenediamines such as laurylbutylenediamine, coconut butylenediamine, n-tridecylbutylenediamine-myristylbutylenediamine, n-pentadecylbutylenediamine, stearylbutylenediamine, n-eicosylbutylenediamine, n-heneicosylbutylenedia-mine, n-docosylbutylendiamine, n-tricosylbutylenediamine, n-pentacosylbutylenediamine, oleylbutylenediamine, beef tallow-butylenediamine, hydrogenated beef tallow-butylenediamine and soy bean butylenediamine; and pentylenediamines such as laurylpentylenediamine, coconut pentylenediamine, myristylpentylenediamine, palmitylpentylenediamine, stearylpentylenediamine, oleyl-pentylenediamine, beef tallow-pentylenediamine, hydrogenated beef tallow-pentylenediamine and soy bean pentylenediamine.

Other illustrative corrosion inhibitors include 2,5-dimercapto-1,3,4-thiadiazoles and derivatives thereof, mercaptobenzothiazoles, alkyltriazoles and benzotriazoles. Examples of dibasic acids useful as corrosion inhibitors, which may be used in the present disclosure, are sebacic acid, adipic acid, azelaic acid, dodecanedioic acid, 3-methyladipic acid, 3-nitrophthalic acid, 1,10-decanedicarboxylic acid, and fumaric acid. The corrosion inhibitors can be a straight or branch-chained, saturated or unsaturated monocarboxylic acid or ester thereof which may optionally be sulfurized in an amount up to 35% by weight. Preferably the acid is a C₄ to C₂₂ straight chain unsaturated monocarboxylic acid. The preferred concentration of this additive is from 0.001% to 0.35% by weight of the total lubricant composition. The preferred monocarboxylic acid is sulfurized oleic acid. However, other suitable materials are oleic acid itself; valeric acid and erucic acid. An illustrative corrosion inhibitor includes a triazole as previously defined. The triazole should be used at a concentration from 0.005% to 0.25% by weight of the total composition. The preferred triazole is tolylotriazole which may be included in the compositions of the disclosure include triazoles, thiazoles and certain diamine compounds which are useful as metal deactivators or metal passivators. Examples include triazole, benzotriazole and substituted to benzotriazoles such as alkyl substituted derivatives. The alkyl substituent generally contains up to 1.5 carbon atoms, preferably up to 8 carbon atoms. The triazoles may contain other substituents on the aromatic ring such as halogens, nitro, amino, mercapto, etc. Examples of suitable compounds are benzotriazole and the tolyltriazoles, ethylbenzotriazoles, hexylbenzotriazoles, octylbenzotriazoles, chlorobenzotriazoles and nitrobenzotriazoles. Benzotriazole and tolyltriazole are particularly preferred. A straight or branched chain saturated or unsaturated monocarboxylic acid which is optionally sulfurized in an amount which may be up to 35% by weight; or an ester of such an acid; and a triazole or alkyl derivatives thereof, or short chain alkyl of up to 5 carbon atoms; n is zero or an integer between 1 and 3 inclusive; and is hydrogen, morpholino, alkyl, amido, amino, hydroxy or alkyl or aryl substituted derivatives thereof; or a triazole selected from 1,2,4 triazole, 1,2,3 triazole, 5-anilo-1,2,3,4-thiatriazole, 3-amino-1,2,4 triazole, 1-H-benzotriazole-1-yl-methylisocyanide, methylene-bis-benzotriazole and naphthotriazole.

The corrosion inhibitors may be used in an amount of 0.01 to 5 wt %, preferably 0.01 to 1.5 wt %, more preferably 0.01 to 0.2 wt %, still more preferably 0.01 to 0.1 wt % (on an as-received basis) based on the total weight of the lubricating oil composition.

### Viscosity Modifiers

Viscosity modifiers (also known as viscosity index improvers (VI improvers), and viscosity improvers) can be included in the lubricant compositions of this disclosure.

Viscosity modifiers provide lubricants with high and low temperature operability. These additives impart shear stability at elevated temperatures and acceptable viscosity at low temperatures.

Suitable viscosity modifiers include high molecular weight hydrocarbons, polyesters and viscosity modifier dispersants that function as both a viscosity modifier and a dispersant. Typical molecular weights of these polymers are between about 10,000 to 1,500,000, more typically between about 20,000 to 1,200,000, and even more typically between about 50,000 and 1,000,000.

Examples of suitable viscosity modifiers are linear or star-shaped polymers and copolymers of methacrylate, butadiene, olefins, or alkylated styrenes. Polyisobutylene is a commonly used viscosity modifier. Another suitable viscosity modifier is polymethacrylate (copolymers of various chain length alkyl methacrylates, for example), some compositions of which also serve as pour point depressants. Other suitable viscosity modifiers include copolymers of ethylene and propylene, hydrogenated block copolymers of styrene and isoprene, and polyacrylates (copolymers of various chain length acrylates, for example). Specific examples include styrene-isoprene or styrene-butadiene based polymers of 50,000 to 200,000 molecular weight.

Olefin copolymers are commercially available from Chevron Oronite Company LLC under the trade designation “PARATONE®” (such as “PARATONE® 8921” and “PARATONE® 8941”); from Afton Chemical Corporation under the trade designation “HiTEC®” (such as “HiTEC® 5850B”; and from The Lubrizol Corporation under the trade designation “Lubrizol® 7067C”. Hydrogenated polyisoprene star polymers are commercially available from Infineum International Limited, e.g., under the trade designation “SV200” and “SV600”. Hydrogenated diene-styrene block copolymers are commercially available from Infineum International Limited, e.g., under the trade designation “SV 50”.

The polymethacrylate or polyacrylate polymers can be linear polymers which are available from Evnoik Industries under the trade designation “Viscoplex®” (e.g., Viscoplex 6-954) or star polymers which are available from Lubrizol Corporation under the trade designation Asteric™ (e.g., Lubrizol 87708 and Lubrizol 87725).

Illustrative vinyl aromatic-containing polymers useful in this disclosure may be derived predominantly from vinyl aromatic hydrocarbon monomer. Illustrative vinyl aromatic-containing copolymers useful in this disclosure may be represented by the following general formula:

A-B

wherein A is a polymeric block derived predominantly from vinyl aromatic hydrocarbon monomer, and B is a polymeric block derived predominantly from conjugated diene monomer.

In an embodiment of this disclosure, the viscosity modifiers may be used in an amount of less than about 10 weight percent, preferably less than about 7 weight percent, more preferably less than about 4 weight percent, and in certain instances, may be used at less than 2 weight percent, preferably less than about 1 weight percent, and more preferably less than about 0.5 weight percent, based on the total weight of the lubricating oil composition. Viscosity modifiers are typically added as concentrates, in large amounts of diluent oil.

The viscosity modifiers may be used in an amount of 0 to 20 wt %, preferably 0.1 to 10 wt %, more preferably 0.5 to 7.5 wt %, still more preferably 1 to 5 wt % (on an as-received basis) based on the total weight of the lubricating oil composition.

As used herein, the viscosity modifier concentrations are given on an “as delivered” basis. Typically, the active polymer is delivered with a diluent oil. The “as delivered” viscosity modifier typically contains from 20 weight percent to 75 weight percent of an active polymer for polymethacrylate or polyacrylate polymers, or from 8 weight percent to 20 weight percent of an active polymer for olefin copolymers, hydrogenated polyisoprene star polymers, or hydrogenated diene-styrene block copolymers, in the “as delivered” polymer concentrate.

### Metal Passivators

The lubricating oil compositions include at least one metal passivator. The metal passivators/deactivators include, for example, benzotriazole, tolyltriazole, 2-mercaptobenzothiazole, dialkyl-2,5-dimercapto-1,3,4-thiadiazole; N,N′-disalicylideneethylenediamine, N,N′-disalicyli-denepropylenediamine; zinc dialkyldithiophosphates and dialkyl dithiocarbamates.

Some embodiments of the disclosure may further comprise a yellow metal passivator. As used herein, “yellow metal” refers to a metallurgical grouping that includes brass and bronze alloys, aluminum bronze, phosphor bronze, copper, copper nickel alloys, and beryllium copper. Typical yellow metal passivators include, for example, benzotriazole, totutriazole, tolyltriazole, mixtures of sodium tolutriazole and tolyltriazole, and combinations thereof. In one particular and non-limiting embodiment, a compound containing tolyltriazole is selected. Typical commercial yellow metal passivators include IRGAMET™-30, and IRGAMET™-42, available from Ciba Specialty Chemicals, now part of BASE, and VANLUBE™ 601 and 704, and CUVAN™ 303 and 484, available from R.T. Vanderbilt Company, Inc.

The metal passivator concentration in the lubricating oils of this disclosure can range from about 0.01 to about 5.0 weight percent, preferably about 0.01 to 3.0 weight percent, and more preferably from about 0.01 weight percent to about 1.5 weight percent, based on the total weight of the lubricating oil.

### Other Additives

The lubricating oil useful in the present disclosure may additionally contain one or more of the other commonly used lubricating oil performance additives including but not limited to polar agents, non-polar agents, ionic liquids, extreme pressure additives, anti-seizure agents, wax modifiers, fluid-loss additives, seal compatibility agents, lubricity agents, anti-staining agents, chromophoric agents, defoamants, demulsifiers, emulsifiers, densifiers, wetting agents, gelling agents, tackiness agents, colorants, lipids (hydrophilic, lipophilic, amphiphilic), phospholipids, glycolipids, glycerophospholipids, lecithin, and others.

Conductivity agents useful in the present disclosure encompass materials, components, chemicals, or fluids having polar functional groups, generally comprising heteroatoms, such as e.g. 0, N, P, S, B, halides, metals, and such polar functional groups generally comprising e.g. esters, ethers, ketones, alcohols, alkoxides, aldehydes, carboxylates, carboxylic acids, carboxylate salts, sulfates, sulfones, sulfonates, sulfinates, heteroatom-metal salts, amine salts, amines, amides, imides, imines, hetero-aromatics, organometallics, and the like. Conductivity agents encompass materials, components, chemicals, or fluids, that increase the conductivity of a comparative fluid by a tangible quantity, e.g. an increment of +100 pS/m or more, when added to such comparative fluid in an effective amount. Conductivity agents may be used individually, or two or more in combination, as treatments or modifiers to compositions of lubricants and work fluids.

An embodiment of this disclosure is the use of a polar basestock, such as for example an ester, to control the dielectric constant of a lubricating or working fluid composition, and consequently to provide control over the value of the conductivity-to-dielectric constant ratio. Such polar basestocks and similarly acting agents are known as dielectric agents. An additional embodiment is the combination of a dielectric agent, such as for example a polar ester basestock, plus a conductivity agent, such as for example a detergent, with such a combination providing surprising control over obtaining desired performance values of the conductivity-to-dielectic constant ratio. Polar basestocks are typically classified as Group V basestocks, and contain non-carbon heteroatoms such as, for example, O, N, S, P, which impart polarity characteristics to the basestock. A dielectric agent increases the dielectric constant of a lubricating or working fluid composition by +0.02 units or more, when used at an effective amount. Also, effective amounts of a dielectric agent can increase the dielectric constant of a lubricating or working fluid composition by 0.02 or more, by 0.04 or more, by 0.06 or more, by 0.08 or more, by 0.1 or more, by 0.15 or more, and sometimes 0.2 or more, depending on concentration. Conductivity agents can function as dielectric agents, and similarly dielectric agents can function as conductivity agents, depending on the concentration of said agent in a lubricating or working fluid composition, and depending on the contribution to the composition's properties for conductivity or dielectric constant or both.

For a review of many commonly used additives, see Klamann in Lubricants and Related Products, Verlag Chemie, Deerfield Beach, Fla.; ISBN 0-89573-177-0. Reference is also made to “Lubricant Additives” by M. W. Ranney, published by Noyes Data Corporation of Parkridge, N.J. (1973); see also U.S. Pat. No. 7,704,930, the disclosure of which is incorporated herein in its entirety. These additives are commonly delivered with varying amounts of diluent oil, that may range from 5 weight percent to 50 weight percent.

The additives useful in this disclosure do not have to be soluble in the lubricating oils. Insoluble additives such as zinc stearate in oil can be dispersed in the lubricating oils of this disclosure.

The types and quantities of performance additives used in combination with the instant disclosure in lubricant compositions are not limited by the examples shown herein as illustrations.

### Ionic Liquids (ILs)

Ionic liquids are so-called salt melts which are preferably liquid at room temperature and/or by definition have a melting point <100° C. They have almost no vapor pressure and therefore have no cavitation properties. In addition, through the choice of the cations and anions in the ionic liquids, the lifetime and lubricating effect of the lubricating oil are increased, and by adjusting the electric conductivity, these liquids can be used in equipment in which there is an electric charge buildup, e.g., electric vehicle powertrains. Suitable cations for ionic liquids include a quaternary ammonium cation, a phosphonium cation, an imidazolium cation, a pyridinium cation, a pyrazolium cation, an oxazolium cation, a pyrrolidinium cation, a piperidinium cation, a thiazolium cation, a guanidinium cation, a morpholinium cation, a trialkylsulfonium cation or a triazolium cation, which may be substituted with an anion selected from the group consisting of [PF₆]⁻, [BF₄]³¹, [CF₃CO₂]³¹, [CF₃SO₃]⁻ as well as its higher homologs, [C₄F₉—SO₃]³¹ or [C₈F₁₇—SO₃]⁻ and higher perfluoroalkylsulfonates, [(CF₃SO₂)₂N]⁻, [(CF₃SO₂)(CF₃COO)N]⁻, [R¹—SO₃]⁻, [R¹—O—SO₃]³¹, [R¹—COO]⁻, Cr⁻, Br⁻, [NO₃]⁻, [N(CN)₂]⁻, [HSO₄]⁻, PF₍₆₋ₓ₎R³ₓ or [R¹R²PO₄]⁻ and the radicals R¹ and R² independently of one another are selected from hydrogen; linear or branched, saturated or unsaturated, aliphatic or alicyclic alkyl groups with 1 to 20 carbon atoms; heteroaryl, heteroaryl-C₁-C₆-alkyl groups with 3 to 8 carbon atoms in the heteroaryl radical and at least one heteroatom of N, O and S, which may be combined with at least one group selected from C₁-C₆ alkyl groups and/or halogen atoms; aryl-aryl C₁-C₆ alkyl groups with 5 to 12 carbon atoms in the aryl radical, which may be substituted with at least one C₁-C₆ alkyl group; R³ may be a perfluoroethyl group or a higher perfluoroalkyl group, x is 1 to 4. However, other combinations are also possible.

Ionic liquids with highly fluorinated anions are especially preferred because they usually have a high thermal stability. The water uptake ability may be reduced significantly by such anions, e.g., in the case of the bis(trifluoromethylsutfonyl)imide anion.

Illustrative ionic liquids include, for example, butylmethylpyrrolidinium bis(trifluoromethylsulfonyl)imide (MBPimide), methylpropylpyrrolidinium bis(trifluoromethylsulfonyl)imide (MPPimide), hexylmethylimidazolium tris(perfluoroethyOtrifluorophosphate (HMIMPFET), hexylmethylimidazolium bis(trifluoromethylsulfonyl)imide (HMIMimide), hexylmethylpyrrolidinium bis(trifluoromethylsulfonyl)imide (HMP), tetrabutylphosphonium tris(perfluoroethyl)trifluorophosphate (BuPPFET), octylmethylimidazolium hexafluorophosphate (OMIM PF6), hexylpyridinium bis(trifluoromethyl)sulfonylimide (Hpyimide), methyltrioctylammonium trifluoroacetate (MOAac), butylmethylpyrrolidinium tris(pentafluoroethyOtrifluorophosphate (MBPPFET), trihexyl(tetradecyl)phosphonium bis(trifluoromethylsulfonyl)imide (HPDimide), hethyl-3-methylimidazolium ethyl sulfate (EMIM ethyl sulfate), 1-ethyl-3-methylimidazolium bis(trifluoromethylsulfonyl)imide (EMIMimide), 1-ethyl-2,3-dimethylimidazolium bis(trifluoromethylsulfonyl)imide (EMMIMimide), N-ethyl-3-methylpyridinium nonafluorobutanesulfonate (EMPyflate), trihexyl(tetradecyl)phosphonium bis(trifluoromethylsulfonyl)amide, trihexyl(tetradecyl)phosphonium bis(2,4,4-trifluoromethylpentyl)phosphinate, tributyl(tetradecyl)phosphonium dodecylbenzenesulfonate, and the like.

Other illustrative ionic liquids include, for example, 1-ethyl-3-methylimidazolium dicyanamide, trihexyltetradecylphosphonium bis(trifluoromethylsulfonyl)amide, trihexyl(tetradecyl)phosphonium bis(2,4,4-trimethylpentyl)phosphinate, 1-methyl-3-butylimidazolium bis (trifluoromethanesulfonyl)imide, and tetradecylammonium bis(2-ethylhexyl) phosphate.

Cation/anion combinations leading to ionic liquids include, for example, dialkylimidazolium, pyridinium, ammonium and phosphonium, etc. with organic anions such as sulfonates, imides, methides, etc., as well as inorganic anions such as halides and phosphates, etc., such that any other combination of cations and anions with which a low melting point can be achieved is also conceivable. Ionic liquids have an extremely low vapor pressure, depending on their chemical structure, are nonflammable and often have thermal stability up to more than 260° C. and furthermore are also suitable as lubricants.

The respective desired properties of the lubricant oil are achieved with the ionic liquids through a suitable choice of cations and anions. These desirable properties include adjusting electrical conductivity of the lubricant to spread the area of use, increasing the service life and lubricating effect of the lubricant, and adjusting the viscosity to improve the temperature suitability. Suitable cations for ionic liquids have proven to be a phosphonium cation, an imidazolium cation, a pyridinium cation or a pyrrolidinium cation which may be combined with an anion containing fluorine and selected from bis(trifluoromethylsulfonyl)imide, bis(perfluoroalkylsulfonyl)imide, perfluoroalkyl sulfonate, tris(perfluoroalkyl)methidenes, bis(perfluoroalkyl)imidenes, bis(perfluoroaryl)imides, perfluoroarylperfluoroalkylsulfonylimides and tris(perfluoro-alkyl) trifluorophosphate or with a halogen-free alkyl sulfate anion.

Ionic liquids useful in the present disclosure are those that are soluble in hydrocarbon, hydrophobic-type, fluids (i.e. oil-soluble), and soluble in suitable lubricating/working fluids. Ionic liquids that are also useful in the present disclosure are those that are soluble in polar, hydrophilic- or amphiphilic-type, fluids (e.g. esters, ethers, etc.), and soluble in suitable lubricating/working fluids. Further, ionic liquids useful in the present disclosure may also be use in solid or semi-solid lubricants such as e.g. greases.

In an embodiment, such ionic liquid additives may be used in an amount of about 0.1 to 10 weight percent, preferably 0.5 to 7.5 weight percent, more preferably about 0.75 to 5 weight percent.

### Antistatic Additives

In electric vehicle powertrains, static electricity is generated, especially when the lubricant is in use. To reduce that hazard, a conductive antistatic additive can be added to and distributed throughout the lubricating oil. This lubricating oil will thereby avoid reduction in its performance associated with local breakdown of the base stock and safety problems from static electric build-up.

A class of products called “antistatic fluids” or “antistatic additives”, which also are petroleum distillates, can be added to adjust the conductivity of a lubricant oil to safe levels, e.g., at or above 100 pico-siemens per meter conductivity. Very small quantities of these antistatic fluids are required to raise the conductivity to the desired levels, namely, some 10 to 30 milliliters per 1,000 gallons of hydrocarbon.

According to another feature of the disclosure, the antistatic additive is selected from a population of commercially available materials based on the ability of the material's chemical compatibility with the lubricating oil and the cost effectiveness of adjusting the conductivity of the lubricating oil to the desired level for the lubricating oil's anticipated application.

Typical antistatic fluids are ExxonMobil™ Chemical's line of de-aromatized hydrocarbon fluids known as Exxsol™ fluids. Representative fluids and their distillation points include Exxsol™ antistatic fluids hexane (65 IBP (° C.) min, 71 DP (° C.) max, and additive amount 30 ml/1000 gal), D 40 (150 IBP (° C.) min, 210 DP (° C.) max, and additive amount 30 ml/1000 gal), D 3135 (152 IBP (° C.) min, 182 DP (° C.) max, and additive amount 10 ml/1000 gal), and D 60 (177 IBP (° C.) min, 220 DP (° C.) max, and additive amount 30 ml/1000 gal). The IBP is the temperature at which 1% of the material is distilled, and the DP is the temperature at which 96% of the material is distilled.

Other illustrative antistatic agents are based on long-chain aliphatic amines (optionally ethoxylated) and amides, quaternary ammonium salts (e.g., behentrimonium chloride or cocamidopropyl betaine), esters of phosphoric acid, polyethylene glycol esters, or polyols. Additional antistatic agents include long-chain alkyl phenols, ethoxylated amines, glycerol esters, such as glycerol monostearate, amides, glycols, and fatty acids.

The quantity of antistatic additive required to adjust the conductivity of the lubricating oil is determined by measuring the conductivity of the lubricating oil as the antistatic additive is mixed in and stopping when the desired conductivity consistent with the application to be reached. The amount of antistatic additive mixed in will range between 0.001% and 10% of the lubricating oil by weight, and preferentially between 1% and 7.5% by weight, though it may be mixed in at a liquid volume of between 10 and 100,000 parts per million.

### Pour Point Depressants (PPDs)

Conventional pour point depressants (also known as lube oil flow improvers) may be added to the lubricating oil compositions of the present disclosure if desired. These pour point depressant may be added to lubricating compositions of the present disclosure to lower the minimum temperature at which the fluid will flow or can be poured. Examples of suitable pour point depressants include polymethacrylates, polyacrylates, polyarylamides, condensation products of haloparaffin waxes and aromatic compounds, vinyl carboxylate polymers, and terpolymers of dialkylfumarates, vinyl esters of fatty acids and allyl vinyl ethers. U.S. Pat. Nos. 1,815,022; 2,015,748; 2,191,498; 2,387,501; 2,655, 479; 2,666,746; 2,721,877; 2,721,878; and 3,250,715 describe useful pour point depressants and/or the preparation thereof. Such additives may be used in an amount of about 0.01 to 5 weight percent, preferably 0.1 to 3 weight percent, more preferably about 0.5 to 1.5 weight percent.

### Seal Compatibility Agents

The lubricating oil compositions can include at least one seas' compatibility agent. Seal compatibility agents help to swell elastomeric seals by causing a chemical reaction in the fluid or physical change in the elastomer. Suitable seal compatibility agents for lubricating oils include organic phosphates, aromatic esters, aromatic hydrocarbons, esters (butylbenzyl phthalate, for example), and polybutenyl succinic anhydride. Such additives may be used in an amount of about 0.01 to 5 weight percent, preferably 0.1 to 3 weight percent, more preferably about 0.5 to 1.5 weight percent.

### Antifoam Agents

Antifoam agents may advantageously be added to lubricant compositions. These agents retard the formation of stable foams. Silicones and organic polymers are typical antifoam agents. For example, polysiloxanes, such as silicon oil or polydimethyl siloxane, provide antifoam properties. Antifoam agents are commercially available and may be used in conventional minor amounts along with other additives such as demulsifiers; usually the amount of these additives combined is less than 1 weight percent and often less than 0.1 weight percent. In an embodiment, such additives may be used in an amount of about 0.01 to 5 weight percent, preferably 0.1 to 3 weight percent, more preferably about 0.5 to 1.5 weight percent.

### Friction Modifiers

The lubricating oil compositions can include at least one friction modifier. A friction modifier is any material or materials that can alter the coefficient of friction of a surface lubricated by any lubricant or fluid containing such material(s). Friction modifiers, also known as friction reducers, or lubricity agents or oiliness agents, and other such agents that change the ability of base oils, lubricant compositions, or functional fluids, to modify the coefficient of friction of a lubricated surface may be effectively used in combination with the base oils or lubricant compositions of the present disclosure if desired. Friction modifiers that lower the coefficient of friction are particularly advantageous in combination with the base oils and lube compositions of this disclosure.

Illustrative friction modifiers may include, for example, organometallic compounds or materials, or mixtures thereof. Illustrative organometallic friction modifiers useful in the lubricating engine oil compositions of this disclosure include, for example, molybdenum amine, molybdenum diamine, an organotungstenate, a molybdenum dithiocarbamate, molybdenum dithiophosphates, molybdenum amine complexes, molybdenum carboxylates, and the like, and mixtures thereof. Similar tungsten based compounds may be preferable.

Other illustrative friction modifiers useful in the lubricating engine oil compositions of this disclosure include, for example, alkoxylated fatty acid esters, alkanolamides, polyol fatty acid esters, borated glycerol fatty acid esters, fatty alcohol ethers, and mixtures thereof.

Illustrative alkoxylated fatty acid esters include, for example, polyoxyethylene stearate, fatty acid polyglycol ester, and the like. These can include polyoxypropylene stearate, polyoxybutylene stearate, polyoxyethylene isosterate, polyoxypropylene isostearate, polyoxyethylene palmitate, and the like.

Illustrative alkanolamides include, for example, lauric acid diethylalkanolamide, palmic acid diethylalkanolamide, and the like. These can include oleic acid diethyalkanolamide, stearic acid diethylalkanolamide, oleic acid diethylalkanolamide, poly ethoxylated hydrocarbylamides, polypropoxylated hydrocarbylamides, and the like.

Illustrative polyol fatty acid esters include, for example, glycerol mono-oleate, saturated mono-, di-, and tri-glyceride esters, glycerol mono-stearate, and the like. These can include polyol esters, hydroxyl-containing polyol esters, and the like.

Illustrative borated glycerol fatty acid esters include, for example, borated glycerol mono-oleate, borated saturated mono-, di-, and tri-glyceride esters, borated glycerol mono-sterate, and the like. In addition to glycerol polyols, these can include trimethylolpropane, pentaerythritol, sorbitan, and the like. These esters can be polyol monocarboxylate esters, polyol dicarboxylate esters, and on occasion polyoltricarboxylate esters. Preferred can be the glycerol mono-oleates, glycerol dioleates, glycerol trioleates, glycerol monostearates, glycerol distearates, and glycerol tristearates and the corresponding glycerol monopalmitates, glycerol dipalmitates, and glycerol tripalmitates, and the respective isostearates, linoleates, and the like. On occasion the glycerol esters can be preferred as well as mixtures containing any of these. Ethoxylated, propoxylated, butoxylated fatty acid esters of polyols, especially using glycerol as underlying polyol can be preferred.

Illustrative fatty alcohol ethers include, for example, stearyl ether, myristyl ether, and the like. Alcohols, including those that have carbon numbers from C₃ to C₅₀, can be ethoxylated, propoxylated, or butoxylated to form the corresponding fatty alkyl ethers. The underlying alcohol portion can preferably be stearyl, myristyl, C₁₁-C₁₃ hydrocarbon, oleyl, isosteryl, and the like.

The lubricating oils of this disclosure exhibit desired properties, e.g., wear control, in the presence or absence of a friction modifier.

Useful concentrations of friction modifiers may range from 0.01 weight percent to 5 weight percent, or about 0.1 weight percent to about 2.5 weight percent, or about 0.1 weight percent to about 1.5 weight percent, or about 0.1 weight percent to about 1 weight percent. Concentrations of molybdenum-containing materials are often described in terms of Mo metal concentration. Advantageous concentrations of Mo may range from 25 ppm to 700 ppm or more, and often with a preferred range of 50-200 ppm. Friction modifiers of all types may be used alone or in mixtures with the materials of this disclosure. Often mixtures of two or more friction modifiers, or mixtures of friction modifier(s) with alternate surface active material(s), are also desirable.

### Extreme Pressure Agents

The lubricating oil compositions can include at least one extreme pressure agent (EP). EP agents that are soluble in the oil include sulfur- and chlorosulfur-containing EP agents, chlorinated hydrocarbon EP agents and phosphorus EP agents. Examples of such EP agents include chlorinated wax; sulfurized olefins (such as sulfurized isobutylene), organic sulfides and polysulfides such as dibenzyldisulfide, bis-(chlorobenzyl)disulfide, dibutyl tetrasulfide, sulfurized methyl ester of oleic acid, sulfurized alkylphenol, sulfurized dipentene, sulfurized terpene, and sulfurized Diels-Alder adducts; phosphosulfurized hydrocarbons such as the reaction product of phosphorus sulfide with turpentine or methyl oleate; phosphorus esters such as the dihydrocarbon and trihydrocarbon phosphites, e.g., dibutyl phosphite, diheptyl phosphite, dicyclohexyl phosphite, pentylphenyl phosphite; dipentylphenyl phosphite, tridecyl phosphite, distearyl phosphite and polypropylene substituted phenol phosphite; metal thiocarbamates such as zinc dioctyldithio carbamate and barium heptylphenol diacid; amine salts of alkyl and dialkylphosphoric acids or derivatives; and mixtures thereof (as described in U.S. Pat. No. 3,197,405).

The extreme pressure agents may be used in an amount of 0.01 to 5 wt %, preferably 0.01 to 1.5 wt %, more preferably 0.01 to 0.2 wt %, still more preferably 0.01 to 0.1 wt % (on an as-received basis) based on the total weight of the lubricating oil composition.

When lubricating oil compositions contain one or more of the additives discussed above, the additive(s) are blended into the composition in an amount sufficient for it to perform its intended function. Typical amounts of such additives useful in the present disclosure are shown in Table 1 below.

It is noted that many of the additives are shipped from the additive manufacturer as a concentrate, containing one or more additives together, with a certain amount of base oil diluents. Accordingly, the weight amounts in the table below, as well as other amounts mentioned herein, are directed to the amount of active ingredient (that is the non-diluent portion of the ingredient). The weight percent (wt %) indicated below is based on the total weight of the lubricating oil composition.

TABLE 1
Typical Amounts of Lubricating Oil Components

| | Approximate wt % | Approximate wt % |
|---|---|---|
| Compound | (Useful) | (Preferred) |
| Antioxidant | 0.01-5 | 0.1-1.5 |
| Dispersant | 0.01-20 | 0.1-10 |
| Detergent | 0.01-10 | 0.1-7.5 |
| Antiwear | 0.01-5 | 0.5-4 |
| Viscosity Modifier | 0-20 | 0.1-10 |
| (solid polymer basis) | | |
| Corrosion Inhibitor | 0.01-5 | 0.1-2 |
| Metal Passivator | 0.01-5 | 0.1-1.5 |
| Friction Modifier | 0-5 | 0.1-1.5 |
| Pour Point Depressant | 0-5 | 0.01-1.5 |
| Antifoam Agent | 0-3 | 0.001-0.15 |
| Extreme Pressure Agent | 0-5 | 0.01-2 |
| Anti-Static | 0-10 | 0.1-5 |
| Ionic Liquid | 0-10 | 0.1-5 |

These additives may be added independently but are usually precombined in packages which can be obtained from suppliers of lubricant oil additives. Additive packages with a variety of ingredients, proportions and characteristics are available and selection of the appropriate package will take the requisite use of the ultimate composition into account.

The following non-limiting examples are provided to illustrate the disclosure.

### Examples

Lubricating oil compositions were prepared as described herein.

The additive packages used in the comparative compositions (Table 2) included one or more additives in effective amounts. Additives used in the compositions were one or more of an antioxidant, dispersant, detergent, antiwear agent, corrosion inhibitor, viscosity modifier, and metal passivator. Optional additives were one or more of a pour point depressant, metal deactivator, seal compatibility additive, antifoam agent, extreme pressure agent, and friction modifier. For the inventive examples disclosed herein, the inventive example compositions used the additive package identified by the comparative oil listed in the respective tables, with the appropriate comparative oil composition as recited in Table 2.

TABLE 2
Comparative Oils;
Compositions & Properties

| | Comparative 3 | Comparative 4 | Comparative 5 | Comparative 6 | Comparative 7 | Comparative 8 | Comparative 9 |
|---|---|---|---|---|---|---|---|
| Composition | | | | | | | |
| (Wt %) | | | | | | | |
| Basestocks | | | | | | | |
| Group II | 40 | | | 40 | 40 | | |
| Group III | 39 | 21 | | 40 | 40 | | 40 |
| Group IV | | 60 | 77 | | 5 | 94 | 36 |
| Group V | 10 | 10 | | 10 | | 5 | 5 |
| Additive | 11 | 9 | 23 | 10 | 15 | 1 | 19 |
| Package | | | | | | | |
| Properties | | | | | | | |
| Ratio | 286 | 749 | 1980 | 27 | 628 | 1.5 | 8222 |
| Conductivity/ | | | | | | | |
| Dielectric | | | | | | | |
| Constant | | | | | | | |
| Conductivity, | 694 | 1850 | 4910 | 62 | 1463 | 3.4 | 19240 |
| pS/m | | | | | | | |
| Dielectric | 2.43 | 2.18 | 2.48 | 2.32 | 2.33 | 2.20 | 2.34 |
| Constant | | | | | | | |
| Viscosity, | 4.88 | 5.39 | 6.24 | 4.82 | 5.34 | 4.06 | 10.76 |
| KV100 | | | | | | | |
| Viscosity, | 16.85 | | 29.48 | 16.77 | 23.75 | | 57.22 |
| KV40 | | | | | | | |

Lubricating oils for electric vehicle powertrains were prepared by blending at least one lubricating oil base stock selected from a Group I, Group II, Group III, Group IV, Group V base oil, and combinations thereof, with one or more lubricating oil additives selected from an antioxidant, a detergent, a dispersant, an antiwear additive, a corrosion inhibitor, a viscosity modifier, a metal passivator, a pour point depressant, a metal deactivator, a seal compatibility additive, an antifoam agent, an extreme pressure agent, a friction modifier, other performance additives, and combinations thereof.

Conductivity agents included in these examples are listed in Table A.

TABLE A
Conductivity Agents

| Conductivity | | |
|---|---|---|
| Agents | Class | Description |
| IL-1 | Ionic Liquid (IL) | 1-Ethyl-3-methylimidazolium |
| | | dicyanamide |
| IL-2 | Ionic Liquid (IL) | Trihexyltetradecylphosphonium |
| | | bis(trifluoromethylsulfonyl)amide |
| IL-3 | Ionic Liquid (IL) | Trihexyl(tetradecyl)phosphonium |
| | | bis(2,4,4-trimethylpentyl)phosphinate |
| IL-4 | Ionic Liquid (IL) | Tributyl(tetradecyl)phosphonium |
| | | dodecylbenzenesulfonate |
| IL-5 | Ionic Liquid (IL) | 1-Methyl-3-butylimidazolium bis |
| | | (trifluoromethanesulfonyl)imide |
| IL-6 | Ionic Liquid (IL) | Tetradecylammonium bis(2-ethylhexyl) |
| | | phosphate |
| PL-1 | phospholipid (PL) | L-α-Phosphatidylcholine |
| PL-2 | phospholipid (PL) | Lecithin |
| FA-1 | fatty acid (FA) | Stearic Acid |
| Disp-1 | Dispersant (Disp) | Alkyl Succinimide (nominal MW 4000) |
| Disp-2 | Dispersant (Disp) | Zinc-modified alkyl succinimide |
| Disp-3 | Dispersant (Disp) | Alkyl Succinimide (nominal MW 5000) |
| Disp-4 | Dispersant (Disp) | Borated alkyl succinimide |
| | | (nominal MW 3000) |
| Det-1 | Detergent (Det) | Ca alkyl salicylate (low base) |
| Det-2 | Detergent (Det) | Ca alkyl salicylate (mixed bases) |
| Det-3 | Detergent (Det) | Ca sulfonate (neutral) |
| ZDDP-1 | Antiwear | Zinc dialkyl dithiophosphate |
| Ester-1 | Ester fluid | Diethylhexyl azelate |

Electrical conductivity increases to low-conductivity oil are demonstated in Table 3, where conductivity agents such as ionic liquids (IL-1, IL-3, IL-5, IL-6), phospholipids (PL-1, PL-2), and fatty acid (FA-1), were added to low-conductivity oil Comparative 3. Increases in conductivity of greater than +100 pS/m were obtained in all Examples 3.1 to 3.10. Further, Examples 3.1 to 3.8 have ratios of conductivity-to-dielectric constant of less than 1,000, and thus have performances with improved protection against battery charge drainage. Examples 3.9 and 3.10 demonstrated use of conductivity agents (IL-3, PL-2) at higher dose concentrations (about +0.3% or above in these cases) to achieve high conductivities in the performance space where the ratio of conductivity-to-dielectric constant is equal to or greater than 1,000, and thus have performances with improved protection against bearing electrical discharge.

TABLE 3
Effect of Conductivity Agents on Oils with Conductivity-to-Dielectric Constant Ratio >200

| | Comparative | Example | Example | Example | Example | Example | Example | Example | Example | Example | Example |
|---|---|---|---|---|---|---|---|---|---|---|---|
| | 3 | 3.1 | 3.2 | 3.3 | 3.4 | 3.5 | 3.6 | 3.7 | 3.8 | 3.9 | 3.10 |
| Composition | | | | | | | | | | | |
| (Wt %) | | | | | | | | | | | |
| Comparative 3 | 100 | 99.9 | 99.95 | 99.9 | 99.95 | 99.95 | 99.95 | 99.95 | 99.95 | 99.5 | 99.5 |
| Conductivity | | | | | | | | | | | |
| Agents | | | | | | | | | | | |
| IL-1 | | 0.1 | | | | | | | | | |
| IL-3 | | | 0.05 | 0.1 | | | | | | 0.5 | |
| IL-5 | | | | | 0.05 | | | | | | |
| IL-6 | | | | | | 0.05 | | | | | |
| PL-1 | | | | | | | 0.05 | | | | |
| PL-2 | | | | | | | | 0.05 | | | 0.5 |
| FA-1 | | | | | | | | | 0.05 | | |
| Properties | | | | | | | | | | | |
| Ratio | 286 | 708 | 385 | 479 | 662 | 376 | 644 | 528 | 595 | 1847 | 2286 |
| Conductivity/ | | | | | | | | | | | |
| Dielectric | | | | | | | | | | | |
| Constant | | | | | | | | | | | |
| Conductivity, | 694 | 1650 | 900 | 1120 | 1550 | 880 | 1500 | 1230 | 1380 | 4360 | 5350 |
| pS/m | | | | | | | | | | | |
| Dielectric | 2.43 | 2.33 | 2.34 | 2.34 | 2.34 | 2.34 | 2.33 | 2.33 | 2.32 | 2.36 | 2.34 |
| Constant | | | | | | | | | | | |

Electrical conductivity increases to moderate-conductivity oil are demonstated in Table 4, where conductivity agents such as ionic liquids (IL-1, IL-3), and phospholipid (PL-2), were added to moderate-conductivity oil Comparative 4. Increases in conductivity of greater than +100 pS/m were achieved in Examples 4.1, 4.3, 4.4, and 4.5. Example 4.2 illustrates that IL-3 required a dose of greater than about +0.1% to achieve the desired+100 pS/m increase versus Comparative 4. Examples 4.1 to 4.3 had ratios of conductivity-to-dielectric constant of less than 1,000, and thus had performances with improved protection against battery charge drainage. Examples 4.4 and 4.5 demonstrated use of conductivity agents (IL-3, PL-2) at higher dose concentrations to obtain ratios of conductivity-to-dielectric constant equal to or greater than 1,000, and thus had performances with improved protection against bearing electrical discharge.

TABLE 4
Effect of Conductivity Agents on Oils with Conductivity-to-Dielectric Constant Ratio >700

| | | Example | Example | Example | Example | Example |
|---|---|---|---|---|---|---|
| | Comparative 4 | 4.1 | 4.2 | 4.3 | 4.4 | 4.5 |
| Composition (Wt %) | | | | | | |
| Comparative 4 | 100 | 99.9 | 99.9 | 99.95 | 99.5 | 99.5 |
| Conductivity Agents | | | | | | |
| IL-1 | | 0.1 | | | | |
| IL-3 | | | 0.1 | | 0.5 | |
| PL-2 | | | | 0.05 | | 0.5 |
| Properties | | | | | | |
| Ratio | 749 | 954 | 854 | 959 | 1204 | 2023 |
| Conductivity/Dielectric | | | | | | |
| Constant | | | | | | |
| Conductivity, pS/m | 1850 | 2090 | 1870 | 2100 | 2660 | 4450 |
| Dielectric Constant | 2.18 | 2.19 | 2.19 | 2.19 | 2.21 | 2.20 |

Electrical conductivity increases to higher-conductivity oil are demonstrated in Table 5, where conductivity agents such as ionic liquids (IL-1, IL-2, IL-3, IL-4), and phospholipid (PL-2), were added to higher-conductivity oil Comparative 5. Increases in conductivity of greater than +100 pS/m were achieved in Examples 5.1 to 5.7, and 5.9. Example 5.8 illustrates that PL-2 required a dose of greater than about +0.05% to achieve the desired+100 pS/m increase versus Comparative 5. All Examples 5.1 to 5.9 demonstrate use of conductivity agents to obtain ratios of conductivity-to-dielectric constant equal to or greater than 1,000, and thus had performances with improved protection against bearing electrical discharge.

TABLE 5
Effect of Conductivity Agents on Oils with Conductivity-to-Dielectric Constant Ratio >1900

| | | Example | Example | Example | Example | Example | Example | Example | Example | Example |
|---|---|---|---|---|---|---|---|---|---|---|
| | Comparative 5 | 5.1 | 5.2 | 5.3 | 5.4 | 5.5 | 5.6 | 5.7 | 5.8 | 5.9 |
| Composition (Wt %) | | | | | | | | | | |
| Comparative 5 | 100 | 99.9 | 99.5 | 99 | 99.9 | 99.9 | 99.5 | 99.9 | 99.95 | 99.5 |
| Conductivity Agents | | | | | | | | | | |
| IL-1 | | 0.1 | 0.5 | 1 | | | | | | |
| IL-2 | | | | | 0.1 | | | | | |
| IL-3 | | | | | | 0.1 | 0.5 | | | |
| IL-4 | | | | | | | | 0.1 | | |
| PL-2 | | | | | | | | | 0.05 | 0.5 |
| Properties | | | | | | | | | | |
| Ratio | 1980 | 3310 | 3747 | 4117 | 2980 | 2844 | 3571 | 4064 | 1943 | 2810 |
| Conductivity/Dielectric | | | | | | | | | | |
| Constant | | | | | | | | | | |
| Conductivity, pS/m | 4910 | 8210 | 9330 | 10210 | 7420 | 7110 | 8820 | 10160 | 4800 | 6940 |
| Dielectric Constant | 2.48 | 2.48 | 2.49 | 2.48 | 2.49 | 2.50 | 2.47 | 2.50 | 2.47 | 2.47 |

Table 6 illustrates that a selected dispersant, in combination with one or more performance additives, or in combination with a selected performance additive package, increases the conductivity of a typical lubricating or working fluid. Example 6.2 illustrates that dispersant Disp-2 gives a surprisingly large increase in the conductivity of a low-conductivity oil Comparative 6, and obtains conductivity a ratio of conductivity-to-dielectric constant of about 721, i.e. less than about 1000, and thus has performance for improved protection against battery charge drainage. Use of Disp-2 at a higher concentration in a suitable finished lubricating or working fluid achieved ratios of conductivity-to-dielectric constant equal to or greater than 1,000 and thus had performance with improved protection against bearing electrical discharge.

TABLE 6
Effect of Dispersants as Conductivity Agents

| | Comparative | Example | Example | Example |
|---|---|---|---|---|
| | 6 | 6.1 | 6.2 | 6.3 |
| Composition (Wt %) | | | | |
| Comparative 6 | 100 | 99 | 98.5 | 99.3 |
| Conductivity Agents | | | | |
| Disp-1 | | 1.0 | | |
| Disp-2 | | | 1.5 | |
| Disp-3 | | | | 0.7 |
| Properties | | | | |
| Ratio Conductivity/ | 27 | 286 | 721 | 259 |
| Dielectric Constant | | | | |
| Conductivity, pS/m | 62 | 694 | 1751 | 626 |
| Dielectric Constant | 2.32 | 2.43 | 2.43 | 2.42 |
| Viscosity, KV100 | 4.82 | 4.88 | 4.91 | 4.87 |
| Viscosity, KV40 | 16.8 | 16.8 | 17.2 | 16.8 |

Electrical conductivity versus, in a test of service life under oxidation conditions, of lubricant Examples 6.1, 6.2, and 6.3, plus a comparative transmission fluid, Comparative 7, is listed in Table 7. Oils were oxidized using a modified version of the ASTM D4310 test, where temperature was maintained at 125C, and test oil was sampled at periodic intervals to measure acidity and conductivity. Typical transmission fluid Comparative 7 performed poorly with loss of control over electrical conductivity, demonstrating a conductivity of 25,000 pS/m after 984 hours time-on-test, i.e a conductivity increase of greater than 15-fold versus that of fresh fluid. In contrast to the comparative transmission fluid Comparative 7, lubricant Examples 6.1, 6.2, and 6.3 exhibited electrical conductivity control within the range of about 2500 pS/m to 6,000 pS/m over about 984 hours time-on-test, i.e. a conductivity increase of about 2-fold to 5-fold increase versus fresh oil. Electrical conductivity control is important for maintaining battery and oil life.

TABLE 7
Oxidation Performance of Oils with Dispersant Conductivity Agents

| Oxidation Life | Comparative 7 | | | Example 6.1 | | | Example 6.2 | | | Example 6.3 | | |
|---|---|---|---|---|---|---|---|---|---|---|---|---|
| Time, hrs | 0 | 984 | 1134 | 0 | 984 | 1134 | 0 | 984 | 1134 | 0 | 984 | 1134 |
| Ratio | 628 | 10504 | 3193 | 286 | 1664 | 1578 | 721 | 2259 | 1599 | 259 | 1012 | 968 |
| Conductivity/ | | | | | | | | | | | | |
| Dielectric | | | | | | | | | | | | |
| Constant | | | | | | | | | | | | |
| Conductivity, pS/m | 1463 | 25000 | 7760 | 694 | 4110 | 3930 | 1751 | 5580 | 3980 | 626 | 2500 | 2400 |
| Dielectric Constant | 2.33 | 2.38 | 2.43 | 2.43 | 2.47 | 2.49 | 2.43 | 2.47 | 2.49 | 2.42 | 2.47 | 2.48 |
| Viscosity (cP), 25 C | 35.5 | 43.4 | 66.81 | 24.2 | 31.0 | 43.5 | 25.8 | 31.7 | 32.94 | 24.6 | 35.5 | 33.06 |
| TAN | 1.51 | 3.03 | 5.90 | 0.43 | 0.78 | 0.56 | 0.70 | 0.77 | 0.72 | 0.51 | 1.04 | 1.19 |
| Copper, ppm | 0 | >68 | | 0 | 39 | | 0 | >62 | | 0 | 41 | |

Further regarding Table 7, oxidation of both the comparative and example oils beyond 984 hours to an extended time of 1134 hours demonstrate decreases in oxidized oil conductivity. These unexpected results are attributed to a process where soluble high-conductivity materials, derived from oxidation, are removed from solution by deposition, thereby lowering the conductivity of the resulting oil compositions. Therefore, such a system of monitoring the conductivity, and other electrical properties, of lubricants and working fluids under oxidizing conditions constitutes a novel sensor system for detecting the relative cleanliness of such fluids in service and for detecting the deposition of insoluble materials onto available surfaces within the service or mechanical environment.

Referring to Table 7, Examples 6.1, 6.2, and 6.3 have compositions in accordance with Table 1 above. Comparative 7 transmission fluid is a typical automatic transmission fluid. Other performance attributes of the electric vehicle powertrain lubricating oils during service life are also illustrated in Table 7. Fluid acidity, as measured by TAN influences electrical conductivity. As oils degrade, TAN increases, and such increases contribute to electrical conductivity increases. Electrical conductivity control is important to decrease the chances of battery drain and electrical breakdown.

Total acid number (TAN) over time, in a test of service life under oxidation conditions, of lubricant Examples 6.1, 6.2, and 6.3, plus a comparative transmission fluid, Comparative 7, is listed in Table 7. Examples 6.1, 6.2, and 6.3 demonstrated good control over TAN, all lower than about 1.2 after 984 hours time-on-test. The comparative transmission fluid, Comparative 7 demonstrated a TAN of about 3.0 after 984 hours time-on-test, which is a typical condemning limit for lubricating oils.

The effect of other performance additives on the electrical properties of lubricant compositions are listed in Table 8a, and illustrate the effects of borated dispersant (Disp-4, Example 8.1), salicylate detergents (Det-1 and Det-2, Examples 8.2 and 8.3), sulfonate detergent (Det-3, Examples 8.4 and 8.5), and a combination of sulfonate detergent and ZDDP antiwear (Det-3 & ZDDP-1, Example 8.6). The use of a polar fluid such as ester base stock (Examples 8.7 and 8.8) illustrates the specific control over the dielectric constant of the lubricant composition, and thus provides additional control over the ratio of conductivity-to-dielectric constant as recited in this disclosure. Further, combinations of polar basestocks and other conductivity agents give additional control in order to obtain targeted, desirable ratios of conductivity-to-dielectric constant. Among these examples of Table 8a, Examples 8.1, 8.2, 8.4, 8.7, and 8.8 have ratios of conductivity-to-dielectric constant of less that about 1,000, thus have performances with improved protection if) against battery charge drainage. Examples 8.3, 8.5, and 8.6 have ratios of conductivity-to-dielectric constant equal to or greater than about 1,000, and thus have performances with improved protection against bearing electrical discharge. Additional illustrative examples are listed in Table 8b.

TABLE 8a
Effect of Additives as Conductivity Agents

| | | Example | Example | Example | Example | Example | Example | Example | Example |
|---|---|---|---|---|---|---|---|---|---|
| | Comparative 8 | 8.1 | 8.2 | 8.3 | 8.4 | 8.5 | 8.6 | 8.7 | 8.8 |
| Composition | | | | | | | | | |
| (Wt %) | | | | | | | | | |
| Comparative 8 | 100 | 99 | 99 | 99 | 99 | 96 | 96 | 75 | 45 |
| Conductivity | | | | | | | | | |
| Agents | | | | | | | | | |
| Disp-4 | | 1 | | | | | | | |
| Det-1 | | | 1 | | | | | | |
| Det-2 | | | | 1 | | | | | |
| Det-3 | | | | | 1 | 4 | 3 | | |
| ZDDP-1 | | | | | | | 1 | | |
| Ester-1 | | | | | | | | 25 | 55 |
| Properties | | | | | | | | | |
| Ratio | 1.5 | 583 | 120 | 1795 | 633 | 1716 | 3593 | 7.3 | 45 |
| Conductivity/Dielectric | | | | | | | | | |
| Constant | | | | | | | | | |
| Conductivity, pS/m | 3.4 | 1282 | 265 | 3950 | 1399 | 3810 | 7940 | 19 | 145 |
| Dielectric Constant | 2.20 | 2.20 | 2.21 | 2.20 | 2.21 | 2.22 | 2.21 | 2.62 | 3.21 |
| Viscosity, KV100 | 4.06 | 4.18 | 4.09 | 4.10 | 4.12 | 4.31 | 4.25 | 3.66 | 3.33 |

TABLE 8b
Illustrative Examples of Conductivity Agents

| | | Example | Example | Example | Example | Example | Example |
|---|---|---|---|---|---|---|---|
| | Comparative 8 | 8.9 | 8.10 | 8.11 | 8.12 | 8.13 | 8.14 |
| Composition (Wt %) | | | | | | | |
| Comparative 8 | 100 | 74 | 98 | 83 | 74 | 81 | 98 |
| Conductivity Agents | | | | | | | |
| Disp-4 | | 1 | 1 | 1 | | | |
| Det-1 | | | 1 | 1 | | | |
| Det-2 | | | | | 1 | | 1 |
| Det-3 | | | | | | 3 | |
| ZDDP-1 | | | | | | 1 | 1 |
| Ester-1 | | 25 | | 15 | 25 | 15 | |
| Properties | | | | | | | |
| Illustrative Ratio | 1.5 | <1000 | <1000 | <1000 | >1000 | >1000 | >1000 |
| Conductivity/Dielectric | | | | | | | |
| Constant | | | | | | | |

Table 9 lists lubricant compositions where conductivity agents are useful in modifying ratios of conductivity-to-dielectric constant where such ratios are high, and in these examples, are greater than about 8,000. Ionic liquids, IL-3 and IL-4, can be effectively used as conductivity agents over a range of concentrations of about 0.01% to 1%, and achieve ratios of conductivity-to-dielectric constant of from about 8,340 up to about 26,440 (Examples 9.1 to 9.4). These examples (Table 9) have ratios of conductivity-to-dielectric constant equal to or greater than about 1,000, and thus have performances with improved protection against bearing electrical discharge.

TABLE 9
Effect of Conductivity Agents on Oils with Conductivity-
to-Dielectric Constant Ratio >8000

| | Comparative | Example | Example | Example | Example |
|---|---|---|---|---|---|
| | 9 | 9.1 | 9.2 | 9.3 | 9.4 |
| Composition (Wt %) | | | | | |
| Comparative 9 | 100 | 99.99 | 99 | 99.99 | 99 |
| Conductivity Agents | | | | | |
| IL-3 | | 0.01 | 1 | | |
| IL-4 | | | | 0.01 | 1 |
| Properties | | | | | |
| Ratio Conductivity/ | 8222 | 8983 | 17016 | 8323 | 26413 |
| Dielectric Constant | | | | | |
| Conductivity, pS/m | 19240 | 21020 | 42200 | 19560 | 65240 |
| Dielectric Constant | 2.34 | 2.34 | 2.48 | 2.35 | 2.47 |
| Viscosity, KV100 | 10.76 | | | | |
| Viscosity, KV40 | 57.22 | | | | |

In an embodiment, compatibility of the lubricating oils of this disclosure with an energized electrical or electronic component can be determined in accordance with the method disclosed in U.S. Application Publication No. 2015/0355122, herein incorporated by reference with regard to such method. In particular, the method involves (a) contacting a test apparatus with lubricating oil; (b) applying an electrical current to the test apparatus; and (c) monitoring the current flow through the test apparatus over time. The test apparatus includes at least one pair of conductors separated by an insulator that does not extend across the whole of the opposing surfaces of the conductors. The electrical current is applied across the pair of conductors.

### PCT and EP Clauses:

1. A method for preventing or minimizing electrostatic discharge and dielectric breakdown in an electric vehicle powertrain, said method comprising providing to an electric vehicle powertrain a lubricating oil having a composition comprising: a lubricating base oil as a major component; an additive package, as a minor component comprising one or more lubricating oil additives; and an effective amount of one or more conductivity agents, as a minor component; wherein the lubricating oil has an electrical conductivity from 10 pS/m to 20,000 pS/m, a dielectric constant of 1.6 to 3.6, and a ratio of electrical conductivity-to-dielectric constant from 1,000 to 10,000.

2. The method of clause 1 wherein the lubricating oil has a kinematic viscosity from 2 cSt to 20 cSt at 100° C., a total acid number (TAN) less than 3, less than 200 ppm active sulfur, and a viscosity index (VI) greater than 50.

3. The method of clauses 1-2 wherein the lubricating oil comprises: at least 70 weight percent of a lubricating base oil.

4. The method of clauses 1-3 wherein the lubricating oil comprises from 0.01 to 30 weight percent of an additive package,

5. The method of clause 1-4 wherein the additive package comprises one or more lubricating oil additives selected from the group consisting of an antioxidant, a detergent, a dispersant, an antiwear agent, a corrosion inhibitor, a viscosity modifier, a metal passivator, a pour point depressant, a seal compatibility agent, an antifoam agent, an extreme pressure agent, a friction modifier, and mixtures thereof.

6. The method of clauses 1-5 wherein the lubricating oil comprises from 0.01 to 30 weight percent of a conductivity agent.

7. The method of clauses 1-6 wherein the lubricating base oil comprises: a blend of a Group IV base stock and a Group V base stock; a blend of a Group III base stock and a Group V base stock; a blend of a Group II base stock and a Group V base stock; or a blend of a Group I base stock and a Group V base stock.

8. The method of clauses 1-7 wherein the one or more conductivity agents are selected from the group consisting of ionic liquids, phospholipids, fatty acids, dispersants, detergents, antiwear agents, polar basestock fluids, and mixtures thereof.

9. The method of clauses 1-8 further including a dielectric agent.

10. The method of clauses 1-9 wherein the electric vehicle powertrain is one or more of an electric motor, an electric drive motor, a transmission, a front axle, a rear axle, a gear box, a differential, gears, bearings, a battery, a capacitor, a generator, an alternator, a converter, a kinetic energy accumulator, a kinetic energy recovery system.

11. The method of clauses 1-10 wherein two or more of the lubricating oils are used in the electric vehicle powertrain, and wherein the two or more lubricating oils are different.

12. A method for lubricating an electric vehicle powertrain in an electric vehicle by preventing or minimizing electrostatic discharge and dielectric breakdown in an electric vehicle powertrain, said method comprising providing to an electric vehicle powertrain a lubricating oil having a composition comprising: a lubricating base oil as a major component; an additive package, as a minor component comprising one or more lubricating oil additives; and an effective amount of one or more conductivity agents, as a minor component; wherein the lubricating oil has an electrical conductivity from 10 pS/m to 20,000 pS/m, a dielectric constant of 1.6 to 3.6, with a ratio of electrical conductivity-to-dielectric constant from 1,000 to 10,000.

13. A method for obtaining a desired electrical conductivity-to-dielectric constant ratio of a lubricating oil for an electric vehicle powertrain, said method comprising: selecting at least one lubricating base oil as a major component; selecting at least one additive package as a minor component, comprising one or more lubricating oil additives; and selecting at least one conductivity agent as a minor component; and blending the selected at least one lubricating oil base stock, and the selected at least one additive package, and an effective amount of the selected at least one conductivity agent, to obtain a desired electrical conductivity-to-dielectric constant ratio of the lubricating oil; wherein the lubricating oil has an electrical conductivity from 10 pS/m to 20,000 pS/m, a dielectric constant of 1.6 to 3.6, with a ratio of electrical conductivity-to-dielectric constant from 1,000 to 10,000.

All patents and patent applications, test procedures (such as ASTM methods, UL methods, and the like), and other documents cited herein are fully incorporated by reference to the extent such disclosure is not inconsistent with this disclosure and for all jurisdictions in which such incorporation is permitted.

When numerical lower limits and numerical upper limits are listed herein, ranges from any lower limit to any upper limit are contemplated. While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside in the present disclosure, including all features which would be treated as equivalents thereof by those skilled in the art to which the disclosure pertains.

The present disclosure has been described above with reference to numerous embodiments and specific examples. Many variations will suggest themselves to those skilled in this art in light of the above detailed description. All such obvious variations are within the full intended scope of the appended claims.

1. A method for preventing or minimizing electrostatic discharge and dielectric breakdown in an electric vehicle powertrain, said method comprising providing to an electric vehicle powertrain a lubricating oil having a composition comprising: a lubricating base oil as a major component; an additive package, as a minor component, comprising one or more lubricating oil additives; and an effective amount of one or more conductivity agents, as a minor component; wherein the lubricating oil has an electrical conductivity from about 10 pS/m to about 20,000 pS/m, a dielectric constant of about 1.6 to about 3.6, and a ratio of electrical conductivity-to-dielectric constant from about 1,000 to about 10,000.

2. The method of claim 1 wherein the lubricating oil has an electrical conductivity from about 1,000 pS/m to about 16,000 pS/m.

3. The method of claim 1 wherein the lubricating oil has a dielectrical constant from about 1.8 to about 3.5.

4. The method of claim 1 wherein the lubricating oil has a kinematic viscosity from about 2 cSt to about 20 cSt at 100° C., a total acid number (TAN) less than about 3, less than about 200 ppm active sulfur, and a viscosity index (VI) greater than about 50.

5. The method of claim 1 wherein the lubricating oil has a kinematic viscosity from about 2 cSt to about 14 cSt at 100° C., a total acid number (TAN) less than about 2, less than about 100 ppm active sulfur, and a viscosity index (VI) greater than about 100.

6. The method of claim 1 wherein the lubricating base oil comprises a Group I, Group II, Group III, Group IV, Group V base stock, or mixtures thereof.

7. The method of claim 1 wherein the lubricating base oil comprises: a blend of a Group IV base stock and a Group V base stock; a blend of a Group III base stock and a Group V base stock; a blend of a Group II base stock and a Group V base stock; or a blend of a Group I base stock and a Group V base stock.

8. The method of claim 1 wherein the lubricating base oil comprises: a blend of a PAO base stock and an alkylated naphthalene or ester base stock; a blend of a GTL base stock and an alkylated naphthalene or ester base stock; or a blend of a Group II base stock and an alkylated naphthalene or ester base stock.

9. The method of claim 1 wherein the lubricating base oil comprises a blend of a PAO base stock having a kinematic viscosity of about 3 cSt to about 250 cSt at 100° C., and an alkylated naphthalene or ester base stock having a kinematic viscosity of about 2 cSt to about 22 cSt at 100° C.; wherein the lubricating oil has a kinematic viscosity from about 4 cSt to about 12 cSt at 100° C.

10. The method of claim 9 wherein the PAO base oil is present in an amount from about 5 to about 95 weight percent of the lubricating oil, and the alkylated naphthalene or ester base oil is present in an amount from about 5 to about 95 weight percent of the lubricating oil.

11. The method of claim 1 wherein the lubricating base oil is present in an amount of from about 70 weight percent to about 95 weight percent, based on the total weight of the lubricating oil.

12. The method of claim 1 wherein the additive package is present in an amount of from about 0.01 to about 30 percent, based on the total weight of the lubricating oil.

13. The method of claim 1 wherein the additive package comprises one or more lubricating oil additives selected from the group consisting of an antioxidant; a detergent; a dispersant; an antiwear agent; a corrosion inhibitor; a viscosity modifier; a metal passivator; a pour point depressant; a seal compatibility agent; an antifoam agent, an extreme pressure agent; a friction modifier; and mixtures thereof.

14. The method of claim 1 wherein the one or more conductivity agents are present in an amount of from about 0.01 to about 30 weight percent, based on the total weight of the lubricating oil.

15. The method of claim 1 wherein the one or more conductivity agents are selected from the group consisting of ionic liquids, phospholipids, fatty acids, dispersants, detergents, antiwear agents, polar basestock fluids, and mixtures thereof.

16. The method of claim 1 further including a dielectric agent.

17. The method of claim 1 wherein the dielectric agent comprises a polar basestock fluid in an amount sufficient to increase the dielectric constant by about 0.02 or more.

18. The method of claim 15 wherein the ionic liquids are present in an amount of from about 0.01 to about 10 weight percent.

19. The method of claim 15 wherein the ionic liquid is selected from the group consisting of 1-ethyl-3-methylimidazoliumdicyanamide, trihexyltetradecylphosphonium bis(trifluoromethylsulfonyl)amide, trihexyl(tetradecyl)phosphonium bis(2,4,4-trimethylpentyl)phosphinate, tributyl(tetradecyl)phosphonium dodecylbenzenesulfonate, 1-methyl-3-butylimidazolium bis (trifluoromethanesulfonyl)imide, and tetradecylammonium bis(2-ethylhexyl) phosphate.

20. The method of claim 15 wherein the phospholipid is L-α-phosphatidylcholine or lecithin.

21. The method of claim 15 wherein the fatty acid is stearic acid.

22. The method of claim 15 wherein the dispersant is selected from the group consisting of ashless alkyl succinimides, metal-modified alkyl succinimides, and mixtures thereof.

23. The method of claim 22 wherein the metal of the metal-modified alkyl succinimides dispersant comprises zinc, boron, or mixtures thereof.

24. The method of claim 15 wherein the detergent is selected from the group consisting of metal alkyl salicylates, metal alkyl sufonates, calcium alkyl salicylates, calcium alkyl sulfonates, low-base calcium alkyl salicylate, high-base calcium alkyl salicylate, neutral calcium alkyl sulfonates, and mixtures thereof.

25. The method of claim 15 wherein the antiwear agent is zinc dialkyl dithiophosphate.

26. The method of claim 15 wherein the polar basestock fluid is diethylhexyl azelate diester.

27. The method of claim 1 wherein the lubricating oil has an operating temperature range of from about 75° C. to about 110° C.

28. The method of claim 1 wherein the electric vehicle powertrain is one or more of an electric motor, an electric drive motor, a transmission, a front axle, a rear axle, a gear box, a differential, gears, bearings, a battery, a capacitor, a generator, an alternator, a converter, a kinetic energy accumulator, or a kinetic energy recovery system.

29. A method for lubricating an electric vehicle powertrain in an electric vehicle by preventing or minimizing electrostatic discharge and dielectric breakdown in an electric vehicle powertrain, said method comprising providing to an electric vehicle powertrain a lubricating oil having a composition comprising: a lubricating base oil as a major component; an additive package, as a minor component comprising one or more lubricating oil additives; and an effective amount of one or more conductivity agents, as a minor component; wherein the lubricating oil has an electrical conductivity from about 10 pS/m to about 20,000 pS/m, a dielectric constant of about 1.6 to about 3.6, with a ratio of electrical conductivity-to-dielectric constant from about 1,000 to about 10,000.

30. A method for obtaining a desired electrical conductivity-to-dielectric constant ratio of a lubricating oil for an electric vehicle powertrain, said method comprising: selecting at least one lubricating base oil as a major component; selecting at least one additive package as a minor component, comprising one or more lubricating oil additives; and selecting at least one conductivity agent as a minor component; and blending the selected at least one lubricating oil base oil, the selected at least one additive package, and an effective amount of the selected at least one conductivity agent, to obtain a desired electrical conductivity-to-dielectric constant ratio of the lubricating oil; wherein the lubricating oil has an electrical conductivity from about 10 pS/m to about 20,000 pS/m, a dielectric constant of about 1.6 to about 3.6, with a ratio of electrical conductivity-to-dielectric constant from about 1,000 to about 10,000.
